(19) United States
(12) Patent Application Publication
(10) Pub. No.: US 2026/0138816 A1
(43) Pub. Date: May 21, 2026

(54) INJECTION MOLDING SYSTEMS FOR FORMING POD HOLDERS AND BEVERAGE PODS, AND ASSOCIATED DEVICES AND METHODS

(71) Applicant: Nexe Innovations Inc., Windsor (CA)

(72) Inventors: Darren Joseph Footz, Surrey (CA); Mohamadreza Falakhoeenejad, Windsor (CA); Paolo Nicolino Incitti, Essex (CA)

(21) Appl. No.: 19/411,038

(22) Filed: Dec. 5, 2025

Related U.S. Application Data
(63) Continuation of application No. PCT/CA2024/050759, filed on Jun. 6, 2024.
(60) Provisional application No. 63/506,540, filed on Jun. 6, 2023.
(60) Provisional application No. 63/512,176, filed on Jul. 6, 2023.
(60) Provisional application No. 63/516,955, filed on Aug. 1, 2023.

(51) Int. Cl. B65D 85/804; A47J 31/06; A47J 31/40; A47J 31/44; B29C 45/80; B29L 31/00

(52) U.S. Cl. CPC B65D 85/8067; A47J 31/0642; A47J 31/407; A47J 31/446; B29C 45/80; B29C 2945/76254; B29C 2945/76568; B29L 2031/762

(57) ABSTRACT

Injection molding systems for forming pod holders and beverage pods, and associated devices and methods are disclosed herein. In some embodiments, an injection molding system including an injection molding apparatus, a feeder, a driver, and a controller. The injection molding apparatus can include a positive molding part comprising a tapered component, and a negative molding part that defines a tapered cavity and a gate in fluid communication with the tapered cavity The gate can be coupled to receive a melted polymer. The feeder can be configured to inject the melted polymer from a source to the gate of the negative molding part. The driver can be configured to move the positive molding part toward or away from the negative molding part. The controller can be operably coupled to the feeder and the driver, and perform a process for operating the injection molding system.

### CROSS-REFERENCE TO RELATED APPLICATIONS

This application is a continuation of International Application No. PCT/CA 2024/050759, filed Jun. 6, 2024, which claims the benefit of U.S. Provisional Ser. No. 63/506,540, filed Jun. 6, 2023, U.S. Provisional Ser. No. 63/512,176, filed Jul. 6, 2023, and U.S. Provisional Ser. No. 63/516,955, filed Aug. 1, 2023, the disclosures of which are incorporated herein by reference in their entireties.

### TECHNICAL FIELD

The present technology relates generally to injection molding systems, and particularly to injection molding systems for forming pod holders and beverage pods, and associated devices and methods.

### BACKGROUND

Single-serve beverage machines, such as the widely recognized Keurig® brewing machines, have gained popularity for their ease of use, convenience, and ability to offer a variety of beverage options. However, these machines and conventional beverage pods possess limitations that have become increasingly evident with evolving consumer preference for bolder flavors and specialty beverages. For example, conventional beverage pods are limited in size, constraining the amount of ingredients that can be stored. This in turn curtails the strength or boldness of beverages that can be brewed, particularly in larger volume servings, leading to relatively weak flavor profiles. Also, specialty beverages can require additional ingredients that compete for the limited space in beverage pods. Accordingly, there is a need for solutions that enable larger beverage pods to be used for brewing beverages with bolder flavors, specialty beverages, etc.

### BRIEF DESCRIPTION OF THE DRAWINGS

Features, aspects, and advantages of the presently disclosed technology may be better understood with regard to the following drawings.

FIG. 1 is an isometric view of a beverage brewing system configured in accordance with at least some embodiments of the present technology.

FIGS. 2A-2D are front isometric, rear isometric, top, and bottom views, respectively, of an adaptive housing configured in accordance with at least some embodiments of the present technology.

FIG. 3 is a cutaway view of the adaptive housing of FIG. 2A taken along plane A-A of FIG. 2C.

FIG. 4 is a cutaway view of the adaptive housing of FIG. 2A taken along plane L-L of FIG. 2C.

FIG. 5 is an enlarged cutaway view of an upper needle included in the adaptive housing of FIG. 2A taken along plane L-L of FIG. 2C.

FIG. 6 is an enlarged cutaway view of a lower needle included in the adaptive housing of FIG. 2A taken along plane L-L of FIG. 2C.

FIG. 7 is an isometric, partially exploded view of a dual-chamber beverage pod configured in accordance with at least some embodiments of the present technology.

FIG. 8 is a cutaway view of the dual-chamber beverage pod of FIG. 7 taken along plane B-B of FIG. 7.

FIG. 9 is a cutaway view of the dual-chamber beverage pod of FIG. 7 disposed in the adaptive housing of FIG. 2A.

FIG. 10 is an isometric view of a single-chamber beverage pod configured in accordance with at least some embodiments of the present technology.

FIG. 11 is a cutaway view of the single-chamber beverage pod of FIG. 10 taken along plane C-C of FIG. 10.

FIGS. 12A and 12B are isometric and side views, respectively, of an injection molding system configured in accordance with at least some embodiments of the present technology.

FIGS. 13A and 13B are side cross-sectional views of the injection molding system of FIG. 12A in an open state and a closed state, respectively.

FIGS. 14A and 14B are isometric and side views, respectively, of another injection molding system configured in accordance with at least some embodiments of the present technology.

FIGS. 15A and 15B are side cross-sectional views of the injection molding system of FIG. 14A in an open state and a closed state, respectively.

FIGS. 16A and 16B are isometric and side views, respectively, of yet another injection molding system configured in accordance with at least some embodiments of the present technology.

FIGS. 17A and 17B are side cross-sectional views of the injection molding system of FIG. 16A in an open state and a closed state, respectively.

FIGS. 18A-18C illustrate an injection molding process in accordance with at least some embodiments of the present technology.

FIG. 19 is a flowchart illustrating a method of operating an injection molding system in accordance with at least some embodiments of the present technology.

FIG. 20 is a side view of the beverage brewing system of FIG. 1.

FIG. 21 is a cross-sectional view of the beverage brewing system of FIG. 1 taken along a first sectional plane S1-S1 of FIG. 20.

FIG. 21A is a cross-sectional view of a dual-chamber beverage pod and an adaptive housing that can be included in the beverage brewing system of FIG. 21.

FIG. 22 is a side view of the beverage brewing system of FIG. 1 and a second sectional plane S2-S2.

FIG. 23 is a cross-sectional view of the beverage brewing system of FIG. 1 taken along the second sectional plane S2-S2 of FIG. 22.

FIGS. 24A and 24B are isometric views of another beverage pod in a disassembled state and an assembled state, respectively, and configured in accordance with at least some embodiments of the present technology.

FIG. 25 illustrates an adaptive housing designed as a retrofit to replace a standard brew basket in a single-serve beverage brewing machine, configured in accordance with at least some embodiments of the present technology.

FIG. 26 illustrates an installation procedure in accordance with at least some embodiments of the present technology.

FIGS. 27A-27D show a multiple compartment pod that can fit inside the adaptive housing and configured in accordance with at least some embodiments of the present technology.

FIGS. 28-31 show a device for adapting a single-serve beverage brewing machine configured to accept a standard size beverage pod in a brew basket, according to at least some embodiments of the present disclosure.

FIGS. 32A-32F show a multiple compartment beverage pod configured according to another embodiment.

FIGS. 33A-33G show a multiple compartment pod configured according to yet another embodiment.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present disclosure relate to injection molding systems for forming pod holders and beverage pods for single-serve beverage machine. Conventional pod holders and beverage pods' are often limited in size, constraining flavor profiles and the types of beverages that can be brewed using single-serve beverage machines. In some embodiments, the present disclosure relates to a component for adapting a single-serve beverage brewing machine to accommodate relative large beverage pods, multi-chamber beverage pods. In some embodiments, the present disclosure relates to an adaptive housing (e.g., a single-serve beverage pod holders) configured to replace a brew basket in a single-serve beverage brewing machine, and provides significant utility and value in the context of beverage brewing. The adaptive housing can be configured to accommodate relatively large capacity beverage pods (e.g., beverage pods larger than standard K-Cup® pods holding 17 grams of grounds), significantly expanding the range of beverage types, strengths, and sizes that can be brewed with a standard single-serve machine. This feature can be particularly beneficial in satisfying consumer preferences for bolder and more customized beverages that require larger amounts of brewing material and/or the inclusion of additional ingredients beyond the capacity of standard-sized pods. Further, the adaptive housing supports enhanced functionality through its internal design. The adaptive housing can be a pod receptacle that secures the larger beverage pod during brewing, while puncturing elements cooperate to facilitate efficient extraction of the beverage material. Additionally, the exit channel aligns with the machine's output spout, ensuring smooth transfer of the brewed beverage. In terms of maintenance and user-friendliness, the adaptive housing can be designed to mimic the size and fit of the original brew basket, the adaptive housing can be inserted into and removed from the machine's brewing compartment without necessitating any modifications to the machine, enabling a straightforward replacement process for users. For example, a portion of the adaptive housing can be geometrically congruent to a corresponding portion of an original brew basket so that the original brew basket can be replaced with the adaptive housing without permanently modifying the machine. A user can repeatedly replace the adaptive housings and original brew baskets for brewing different types of beverages.

The adaptive housing can be configured to reduce cleaning requirements and potential contaminant build-up associated with the original brew basket, promoting both the beverage quality and machine longevity. There has been growing interest in incorporating various additives into beverage pods, such as dry creamers, Medium Chain Triglyceride (MCT) oil, grass-fed butter, Cannabidiol (CBD) or Tetrahydrocannabinol (THC) oil, alcohol, and liquid or dry flavored materials. However, the inclusion of such additives further reduces the available space for the core beverage material, thereby exacerbating the issue of weak beverage flavors. Additionally, the limited volume severely restricts the quantity of additives that can be incorporated into a beverage pod. As one example, a traditional Irish coffee recipe may require at least two fluid ounces of alcohol, such as whisky or Kahlua, in addition to strong coffee. Unfortunately, the total interior volume of a standard K-Cup style pod is less than two fluid ounces, making such a beverage impossible to produce with a single pod. The broader application of the adaptive housing accommodates beverage pods with multiple compartments, each have a holding capacity of 0.25 fluid ounces, 0.5 fluid ounces, 1 fluid ounce, 1.5 fluid ounces, 2 fluid ounces, 3 fluid ounces, or other desire capacity. The brewing of specialty beverages, like those containing soluble additives such as creamers, MCT oil, grass-fed butter, CBD or THC oil, alcohol, or liquid, powders (e.g., protein powder, whey powder, etc.), and/or dry flavored materials. This expands the machine's versatility beyond its original design and functionality, meeting evolving consumer needs for diverse beverage options. The adaptive housing presents a robust solution for enhancing single-serve beverage brewing machines, promising richer, more customized beverage brewing, easier maintenance, and expanded functionality.

In some embodiments, the present disclosure relates to a beverage pod comprising a plurality of chambers, wherein each one of the plurality of chambers is dimensioned to contain a brewing material and/or additives comprising powders, and fats/oils.

In some embodiments, the present disclosure relates to a beverage pod comprising a first chamber and a second chamber. The first and the second chamber are dimensioned to contain a brewing material and/or additives comprising powders. Each of the first and the second chamber can be adapted for puncture by one or more piercing elements. Liquid can flow sequentially or concurrently through the first and the second chambers. The beverage pod can include additional sealed chambers, filters, face plates, sealing films, etc.

In some embodiments, the present disclosure relates to a beverage pod comprising a plurality of chambers dimensioned to contain a brewing material and/or additives (e.g., powders, fats/oils, liquids, etc.). At least one chamber is configured receive hot water upon puncture by a piercing element and increase transit time of the hot water through the at least one chamber to enable steeping of the brewing material. In one aspect, the brewing material is tea. The steeping time can be selected to clean and/or sanitize reusable components of the brewing machine.

In some embodiments, the present invention relates to a beverage pod comprising a plurality of chambers dimensioned to contain a brewing material and/or additives comprising powders, and fats/oils. At least one chambers is configured to receive hot water upon puncture by a piercing element and to promote mixing, such as turbulent mixing of the hot water and the brewing material and/or additives comprising powders, and fats/oils.

In one embodiment, the present disclosure relates to a beverage pod comprising a first chamber for containing a brewing material and a second chamber for containing an alcohol. Each of the first and the second chamber can be adapted for piecing by one or more piercing elements. The first chamber is configured to receive hot water upon puncture by a piercing element. The second chamber is adapted receive the brewed material from the first chamber and is adapted for puncture by a venting element to open a vent channel so as to permit air entry into the second chamber to promote evacuation of a mixture of the brewed material and alcohol from the second chamber. The piercing elements can be positioned at opposite sides of the beverage pod to facilitate flow of the brewing liquid across the first and second chambers. In some embodiments, the venting element can include one or more brewing pins, brewing needles, or the like. The venting elements can pierce portions of the brewing pod to access beverage ingredients, allow beverage ingredients to flow between chambers, exit the beverage pod, or combinations thereof.

In some embodiments, a beverage pod for use in a beverage machine includes multiple beverage compartments. For example, the beverage compartments can include, for example, an upper beverage compartment including an upper opening and an upper chamber containing a first beverage material. A lid can cover the upper opening and the upper beverage compartment. The beverage pod can include a lower compartment defining a lower chamber containing a second beverage material. The lower compartment can include one or more brewing pin-receiving shoulders extending inwardly from a sidewall of the lower compartment. In some embodiments, a pierceable separator or partition can be located between the upper and lower chambers. A gap can be present between the pin-receiving shoulder and the separator such that when a brewing pin passes through the upper pin-receiving shoulder and the separator, the first beverage material can exit the upper chamber. For example, when a brewing pin passes through the pin-receiving shoulder and the separator, a liquid that has mixed with the first beverage material to form a first beverage (e.g., coffee, tea, etc.) can flow downwardly from the upper chamber, along or through the gap, and into the lower chamber. The first beverage can mix with the second beverage material to form a second beverage (e.g., coffee cocktail, syrup flavored coffee or tea, protein infused beverage, etc.). The beverage pod can include any number of compartments and chambers within those compartments to provide for producing different types of beverages.

In some embodiments, a multi-chamber beverage pod for use in a single beverage machine includes an upper portion defining an upper opening and upper chamber containing the first beverage material. The beverage pod can include a lid, a lower portion, and a pierceable separator. The lid can extend across an upper opening of the upper portion. The upper portion can include an upper chamber containing one or more beverage materials. The lower portion can define a lower chamber containing one or more second beverage materials. The lower portion can include one or more brewing pin-receiving shoulders that extend inwardly from a sidewall of the lower portion. A brewing pin can be moved upwardly along a sidewall channel and through the one or more brewing pin-receiving shoulders. The pierceable separator can be located between the upper chamber and lower chamber. The pierceable separator can include, for example, a mono-or multi-layer film integrally formed with or coupled to the upper portion. In some embodiments, the upper portion can be integrally formed with a pierceable separator. For example, the pierceable separator can be a bottom integrally formed with sidewalls of the upper portion.

The multi-chamber beverage pod can further include one or more gaps between the brewing pin-receiving shoulder and the separator such that when a brewing pin passes upwardly through the brewing pin-receiving shoulder and/or the separator, fluid communication between chamber is established. In some examples, a heated liquid delivered into the upper portion can mix with the one or more first beverage materials to form a first beverage. The warm first beverage can flow downwardly from the upper chamber through the brewing pin and/or next to the brewing pin. The first beverage can then flow along at lease a portion of the gap to mix with the one or more second beverage materials in the lower chamber to form a second beverage. The second beverage can then flow out a lower brewing pin and into a container, such as a cup, glass, or container. The user can stir or further mix the second beverage material as desired.

In some embodiments, the present disclosure relates to reusable brew baskets designed to replace conventional pod holders, which restrict the size of beverage pods that can be used and incorporates significant wasted space. The reusable brew baskets can be configured to individually open (e.g., pierce, access, etc.) chambers of multi-chamber beverage pods. For example, conventional pod holders can include many surfaces and components that facilitate the buildup of contaminants that can impair the quality of beverages and pose health and safety risks to users. Conventional pod holders are also designed such that ingredients with high viscosity easily stick thereto, which can lead to clogging and additional safety risks. The present disclose related to disposable beverage pods and a reusable brew basket that cooperate to provide for self-cleaning and/or sanitization of the reusable brew basket. When a new beverage pod is installed in the brew basket, the brew basket may have residual materials from prior brewing. The hot liquid flowing through the beverage pod can sanitize the brew-contacting components of the brew basket to avoid producing a beverage that contains, for example, bacteria.

Embodiments of the present technology allow a greater volume of ingredients to be stored in a single beverage pod, thereby allowing beverages of bolder flavors and specialty beverages to be made using single-serve beverage brewing machines. The beverage pods disclosed herein can also store multiple ingredients separately, and the pod holders can allow the multiple ingredients to be used in brewing the beverage. Moreover, the pod holders and beverage pods disclosed herein can be used in conventional beverage brewing machines, avoiding the need for customers to purchase a separate machine.

In some embodiments, the beverage pod can be configured to clean and/or sanitize one or more components of a brewing machine and/or a brewing basket. For example, residual beverage materials from prior brews can be present along components (e.g., puncturing elements, such as needles) of the brewing basket. These residual beverage materials can include creamers, diary additives (e.g., milk, diary creamers), and other materials that may be prone to, for example, bacterial growth. The beverage pod can be configured to allow heated liquid (e.g., water or the beverage) to flow through the beverage pod so as to sanitize the residual beverage material collected along the one or more components of the brewing basket. For example, the beverage pod can include a chamber holding coffee grounds and one or more additive chambers holding dairy products (e.g., creamer), sugar, syrups, etc. The chambers can be sequentially or concurrently punctured to allow mixing of the beverage materials. The coffee machine can deliver heated liquid through the chambers such that the heated liquid sanitizes reusable components of the brewing machine and/or the brewing basket contacting the beverage. The temperature of the liquid can be selected based on the brewing period, steeping period, etc. For example, water at a temperature equal to or higher than 90 degrees Celsius, 95 degrees Celsius, 100 degrees Celsius, 105 degrees Celsius, 110 degrees Celsius can be intermittently or continuously delivered into the beverage pod for a brewing/steeping period equal to or longer than 30 seconds, 45 seconds, 1 minute, 90 seconds. The temperature and brewing/steeping period can be achieved when producing a desired amount (e.g., 6 fluid ounces, 8 fluid ounces, 12 fluid ounces, 16 fluid ounces, 20 fluid ounces, etc.) of beverage within 30 seconds, 1 minute, 2 minutes, 3 minutes, etc. The heated water can clean and/or sanitize puncturing elements, leaving the post-brewed puncturing element substantially free from, for example, bacteria. This allows beverage baskets to be repeatedly used with multicomponent beverage pods containing bacterial-growth prone beverage ingredients (e.g., dairy based powders, liquid creamers, etc.).

At least some embodiments of the present disclosure address at least some of the above described issues for single-serve beverage brewing. Embodiments of the present disclosure include an injection molding system configured to manufacture adaptive housings, pod holders, beverage pods, single-serve beverage components for a beverage machines, etc. The injection molding system can include an injection molding apparatus, a pump, a driver, and a controller. The injection molding system can include a positive molding part comprising a tapered component and a negative molding part that defines a tapered cavity and at least one gate in fluid communication with the tapered cavity. The gate can be coupled to receive one or more flowable polymers. An injection molding system can be configured to inject the flowable polymer(s) from a source (e.g., a polymer source) to the gate of the negative or cavity molding part. The injection molding system can be configured to move the positive molding part toward or away from the negative molding part. The controller can be operably coupled to the feed or delivery system (e.g., a pump system, an auger system, a runner system), mold cooling system, and a driver. The controller can perform a process comprising steps of: (i) positioning, using the driver, the positive molding part spaced apart from the negative molding part such that the injection molding apparatus is in an open state, (ii) injecting, using the pump, a predetermined volume of the liquid polymer into the tapered cavity via the gate, (iii) moving, using the driver, the positive molding part toward the negative molding part such that the tapered component spreads the predetermined volume of the liquid polymer in the tapered cavity into at least a portion of a container having a groove extending along a side of the container, and such that the injection molding apparatus is in a closed state, (iv) cooling the liquid polymer such that the polymer solidifies and retains a shape of the at least the portion of the container, and/or (v) moving, using the driver, the positive molding part away from the negative molding part such that the injection molding apparatus returns to the open state.

In some embodiments, a system and method for molding, forming, and annealing an article of manufacture using a series of molds are disclosed. Such systems and methods may melt degradable thermoplastic materials that are then injected into a first mold to form an article of manufacture. This article may then be moved to a second mold where the formed article is annealed. The second mold may be heated based on operation of a heating element that heats the annealing mold reservoirs of fluids that may be used to heat and/or cool articles such as single chamber or multi-chamber beverage pods during an annealing process. An optional annealing process may condition materials in the formed article to enhance properties of the article. For example, annealing may improve thermal resistance of the article. Systems of the present disclosure may employ two molds, one mold that forms articles and a second mold that anneals articles to facilitate a continuous production beverage pods using environmentally friendly materials.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

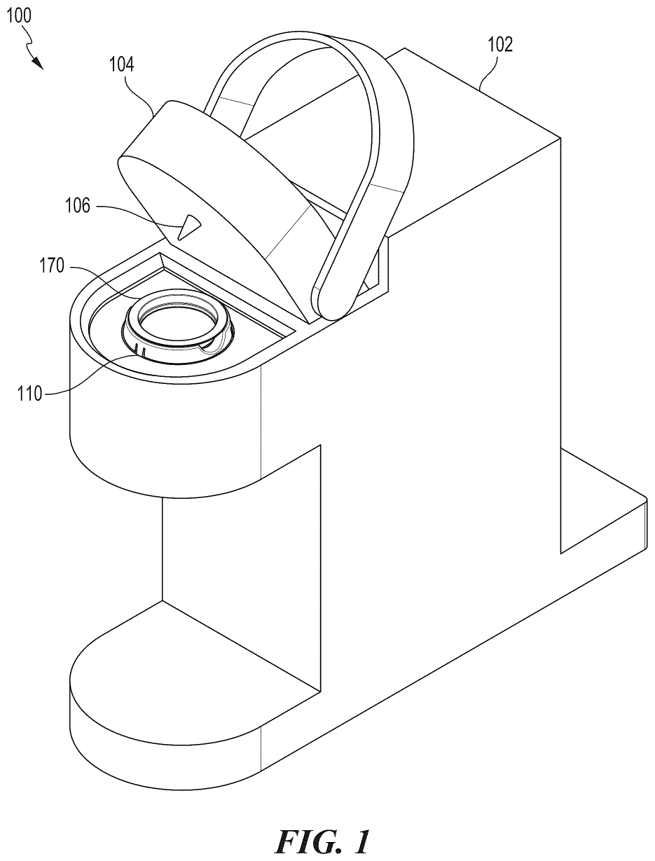

To illustrate, FIG. 1 is an isometric view of a beverage brewing system 100 configured in accordance with embodiments of the present technology. The beverage brewing system 100 can include a beverage brewing machine 102, an adaptive housing or pod holder 110, and a beverage pod 170. The pod holder 110 can have an exterior form factor compatible with or corresponding to conventional beverage brewing machines, and can be inserted into or removed from the beverage brewing machine 102. Therefore, in some embodiments, a user can remove a conventional pod holder (e.g., a pod holder included with the beverage brewing machine 102 when purchased) from the beverage brewing machine 102 and insert the pod holder 110 as a replacement while a lid of the beverage brewing machine 102 is open.

The beverage pod 170 can store one or more ingredients (e.g., coffee blends, milk, alcohol, etc.). The beverage pod 170 can have an exterior form factor compatible with or corresponding to the pod holder 110 such that the beverage pod 170 can be fitted inside the pod holder 110. To make a beverage using the beverage brewing system 100, the user can close the lid 104, which can include a puncture element 106, and operate the beverage brewing machine 102 to initiate the beverage brewing process. The pod holder 110 can facilitate flow of the ingredients from the beverage pod 170 into a cup (not shown) positioned on the beverage brewing machine 102. As discussed further herein, the beverage pod 170 is larger in size compared to conventional beverage pods, and can store a greater quantity of ingredients. In some embodiments, the beverage pod 170 comprises a multi-chamber beverage pod having two or more chambers for storing different ingredients separately. The pod holder 110 can have a form factor that can receive the larger beverage pod 170 (or a conventional beverage pod) while fitting in the beverage brewing machine 102. In some embodiments, the pod holder 110 includes features to enable the flow and/or mixing of the multiple ingredients stored in the beverage pod 170, as discussed further herein.

### II. Adaptive Housings, Pod Holders, and Beverage Pods

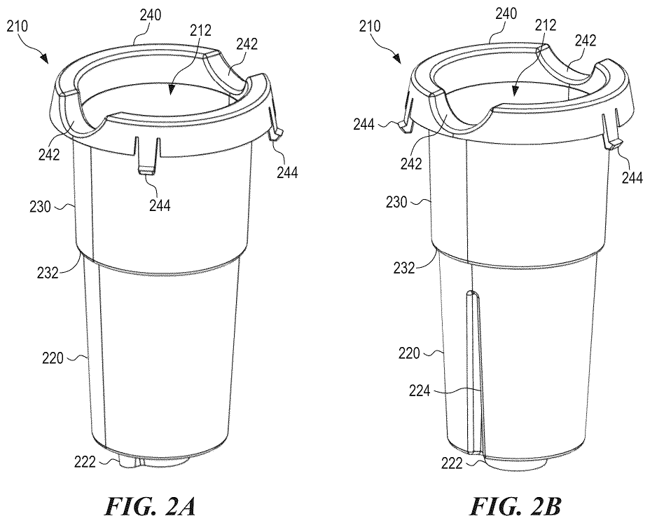

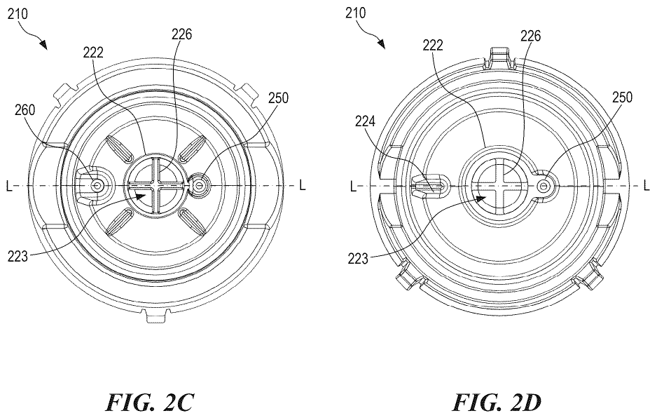

FIGS. 2A-2D are front isometric, rear isometric, top, and bottom views, respectively, of a pod holder 210 (also referred to as “the basket 210”) configured in accordance with embodiments of the present technology. The pod holder 210 can be an example of the pod holder 110 illustrated in FIG. 1.

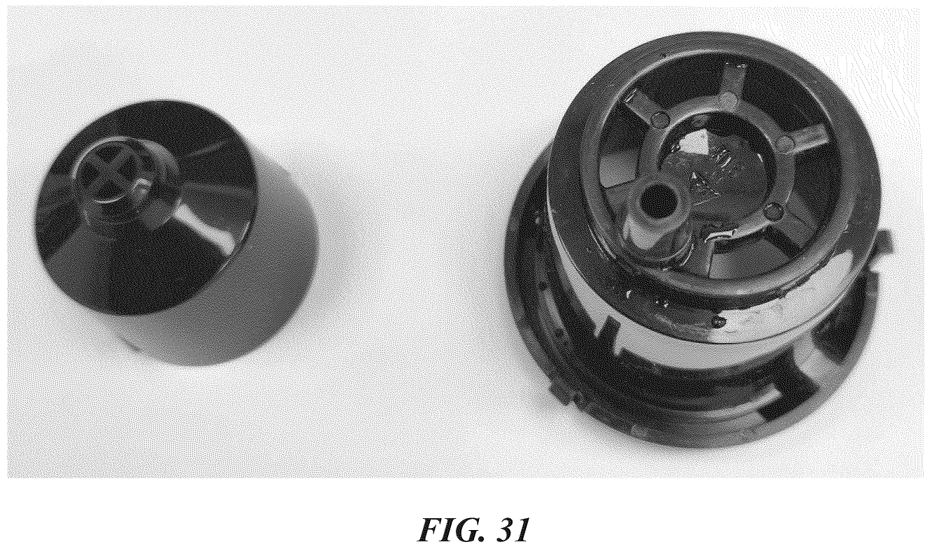

Referring first to FIGS. 2A and 2B, the pod holder 210 can be an adaptive housing that includes a lower portion 220 and an upper portion 230 coupled to a top of the lower portion 220. The lower portion 220 and the upper portion 230 can define a cavity 212 for receiving a beverage pod. In the illustrated embodiment, each of the lower portion 220 and the upper portion 230 comprises a frustoconical portion or a cylinder that is tapered towards a bottom of the pod holder 210. The lower portion 220 and the upper portion 230 can define a shoulder or lip 232 therebetween. The shoulder or lip 232 (“lip 232”) can extend radially outward from the lower portion 220 to the upper portion 230, and can extend circumferentially around the top of the lower portion 220. The diameter of the portion of the lower portion 220 at the lip 232 can be smaller than the diameter of the portion of the upper portion 230 at the lip 232. The lower portion 220 can have a length or height between 2-2.5 inches, and the upper portion 230 can have a length or height between 1.5-2 inches, 1-3 inches, or other desired length. In some embodiments, the lower portion 220 and the upper portion 230 are integrally formed (e.g., via injection molding). In some embodiments, the lower portion 220 and the upper portion 230 are separate components, as shown in FIG. 31.

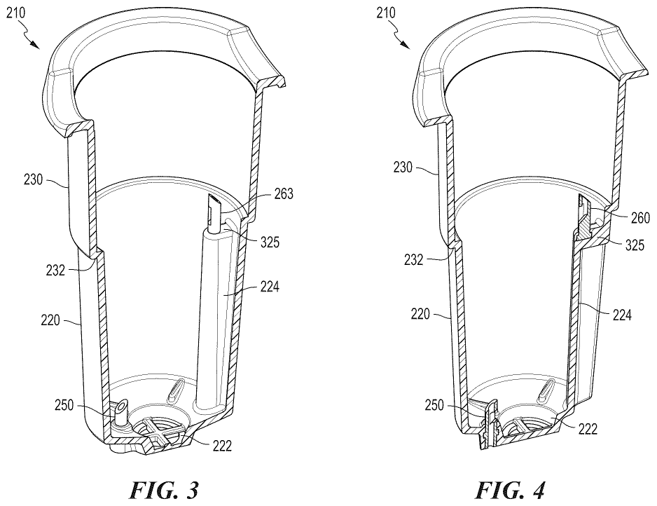

With continued reference to FIGS. 2A and 2B, the lower portion 220 can include a bottom portion 222 and a keying feature, shoulder, or groove 224 (FIG. 2B). The bottom portion 222 can protrude from the bottom of the lower portion 230. In some embodiments, the keying feature or groove 224 extends longitudinally along most of the height of the lower portion 222. The keying feature or groove 224 (“groove 224”) can extend from the bottom of the lower portion 220 vertically (e.g., generally along a longitudinal axis of the pod holder 210) towards, but not reaching, the lip 232. The groove 224 can comprise a U-shaped channel, a tapered recess, or other feature that extends into the interior of the lower portion 220 (as better seen in FIGS. 3 and 4). The protruding keying feature or groove 224 can serve as an alignment feature for aligning the pod holder 210 with a beverage brewing machine (e.g., the beverage brewing machine 102) and/or a beverage pod (e.g., the beverage pod 170).

The upper portion 230 can include a rim 240 having an annular flange that extends from the top of the upper portion 230 and downward and around part of the upper portion 230. The rim 240 can include one or more recesses 242 (two recesses 242 are included in the illustrated embodiment) and a plurality of tines 244. The recesses 242 can provide space for the user's fingers to grab a beverage pod disposed in the cavity 212. The tines 244 can be shaped to releasably secure the pod holder 210 in the beverage brewing machine.

Referring next to FIG. 2C (top view), the pod holder 210 further includes a first puncture element, pin, or needle 250 (“the first needle 250”), a second puncture element, pin, or needle 260 (“the second needle 260”), and one or more struts 226. The first needle 250 and the second needle 260 can both be secured or otherwise coupled to the lower portion 220, and can be aligned along a longitudinal plane L-L of the pod holder 210, as shown. The first and second needles 250, 260 can be positioned on opposite sides of the cavity 212 (FIG. 2A). The bottom portion 222 can define an opening 223 such that the cavity 212 is open at the bottom of the pod holder 210, and the struts 226 can be positioned across the opening. The struts 226 can help stabilize flow passing through the opening when the pod holder 210 is in use. The struts 226 can be arranged in a cross pattern, as shown, or other patterns. Referring next to FIG. 2D (bottom view), the first needle 250 connects the cavity 212 to the external environment at the bottom of the pod holder 210 in addition to the opening 223 at the bottom portion 222. FIG. 2D also illustrates that the protruding keying feature or groove 224 begins at the bottom of the pod holder 210. The opening 223 can comprise an enlarged exit channel, a nozzle, or a valve that ensures the orderly transfer of the beverage.

FIG. 3 is a cutaway view of the pod holder 210 along a sectional plane offset from the longitudinal plane L-L (FIGS. 2C and 2D). FIG. 4 is a cutaway view of the pod holder 210, specifically along the longitudinal plane L-L. Referring to FIGS. 3 and 4 together, the first needle 250 and the second needle 260 are positioned on opposite sides of the bottom portion 222 along the longitudinal plane L-L. The first needle 250 extends vertically upward from the bottom of the lower portion 220, and the second needle 260 extends vertically upward from an interior terminal end 325 of the groove 224. Furthermore, the first needle 250 and the second needle 260 are oriented such that their sharp tips face or are positioned closer to the center of the pod holder 210. The first needle 250 and the second needle 260 can include one or more side-openings or apertures (FIG. 3 shows a side opening of the second needle 260) to allow liquid flow out of the respective first and second needles 250, 260.

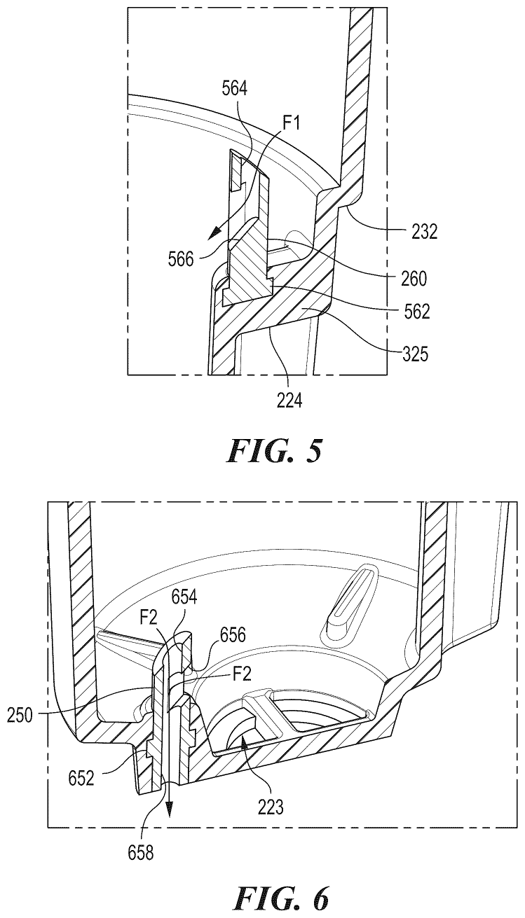

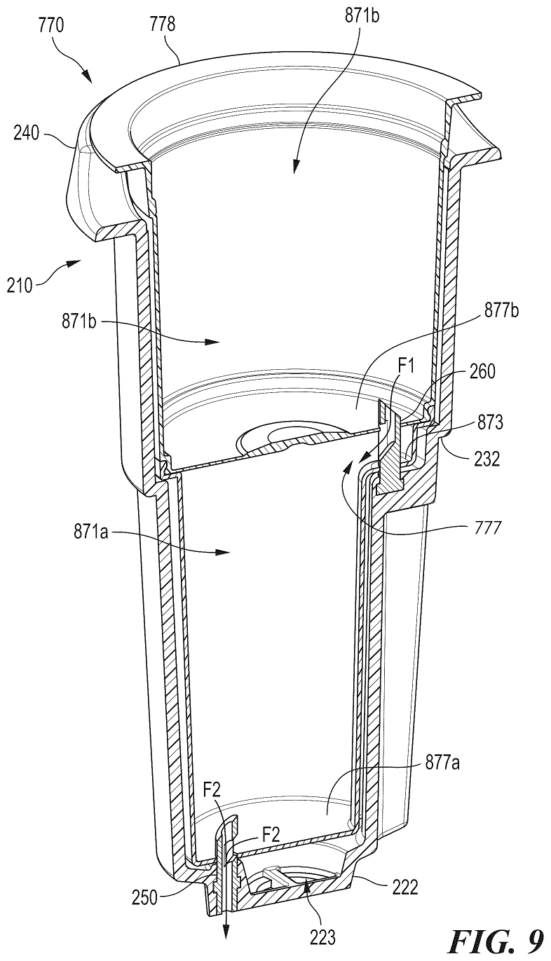

FIG. 5 is an enlarged cutaway view of the second needle 260. The interior terminal end 325 of the groove 224 includes a recess 562 shaped to partially receive and secure the second needle 260 therein. The second needle 260 can include corresponding projections or other features that can keep the second needle 260 secured partially in the recess 562. The second needle 260 includes a first aperture 564 positioned on an end (e.g., the sharp end) of the second needle 260 and a second aperture 566 positioned on a side of the second needle 260. In operation, the second needle 260 can pierce a film included in a beverage pod. The film can be positioned at about the level of the lip 232 such that once the film is pierced, the ingredients stored in the beverage pod can flow along flow path F1 into the first aperture 564 and out through the second aperture 566. Thus, the second needle 260 can direct the ingredients towards the lower portion 220. As shown in FIG. 9, at least a portion of the first aperture 564 is positioned below a separator, a partition, or second film 877b.

FIG. 6 is an enlarged cutaway view of the first needle 250. The bottom portion 222 includes a recess 652 shaped to partially receive and secure the first needle 250 therein. The first needle 250 can include corresponding projections or other features that can keep the first needle 250 secured partially in the recess 652. The first needle 250 includes a first aperture 654 positioned on a first end (e.g., the sharp end) of the first needle 250, a second aperture 656 positioned on a side of the first needle 250, and a third aperture 658 positioned on a second end opposite the first end. As shown in FIGS. 4 and 6, the third aperture 658 is exposed to the external environment. In operation, the first needle 250 can pierce a film included in the beverage pod. The film can be positioned between the first aperture 654 and the second aperture 656 such that once the film is pierced, the ingredients stored in the beverage pod can flow along flow path F2 into the first aperture 654 and out through the second aperture 656 and/or the third aperture 658. In other words, the ingredients are diverted such that (i) a first portion of the flow entering the first needle 250 through the first aperture 654 is directed out through the second aperture 656 and towards the opening 223, and (ii) a second portion of the flow is directed out through the third aperture 658. Thus, the first needle 250 can direct the ingredients towards a cup positioned underneath the pod holder 210 via the opening 223 and/or the third aperture 658.

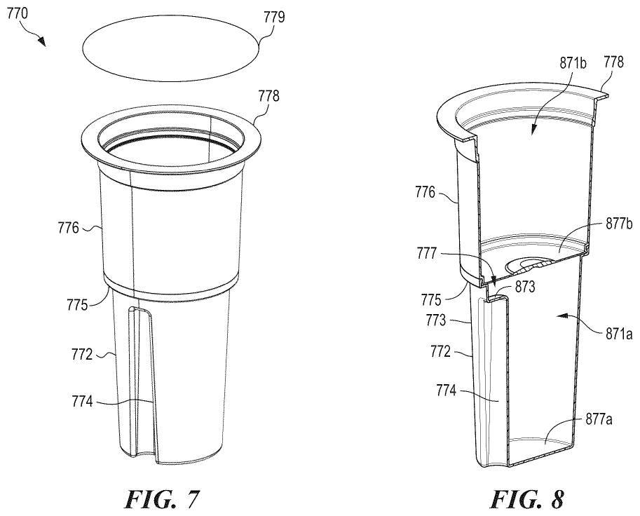

FIG. 7 is an isometric, partially exploded view of a dual-chamber beverage pod 770 configured in accordance with embodiments of the present technology. FIG. 8 is a cutaway view of the dual-chamber beverage pod 770. The dual-chamber beverage pod 770 can be an example of the beverage pod 170 illustrated in FIG. 1. Referring to FIGS. 7 and 8 together, the dual-chamber beverage pod 770 can include a lower portion 772, an upper portion 776, a first bottom film 877a (also referred to as a bottom), a second bottom or film 877b, and a lid, lidding, or third film 779. The lower portion 772 and the upper portion 776 can define a shoulder or lip 775 (“lip 775”) therebetween. The lip 775 can extend radially outward from the lower portion 772 to the upper portion 776, and circumferentially around the top of the lower portion 772.

The lower portion 772 can include a keying feature, shoulder, or groove 774 (“groove 774”) extending inwardly from a sidewall of the lower portion 772, and extending from the bottom of the lower portion 772 and vertically upwards toward, but not reaching, the lip 775. An internal terminal end 873 of the groove 774 can be positioned below the second film 877b. Referring to FIG. 8, the terminal end 873 can be in the form of or include a pin-receiving shoulder that extends inwardly from a sidewall 773 of the lower portion 772 to define a gap 777. The gap 777 can be between an upper surface of the terminal end 873 and the separator or film 877b. A height of the gap 777 can be selected to allow a portion of a brewing pin to be positioned between the upper surface of the terminal end 873 and a lower surface of the separator or film 877b. This allows for fluid to flow downward through the brewing pin and laterally outward from the brewing pin into the chamber 871a. In some embodiments, a distance between the terminal end 873 (e.g., upper surface of the terminal end 873) and the separator can be at least 2 mm, 5 mm, 7 mm, 8 mm, 10 mm, 20 mm, 30 mm, or other distance selected to allow a sufficient length of the brewing pin to be positioned in the gap 777. As shown in FIG. 9, a portion of the brewing pin 260 extends across the gap 777 such that the fluid F1 can flow downwardly through the brewing pin 260 and into the lower chamber 871a.

Referring again to FIGS. 7 and 8 together, the upper portion 776 can include a rim 778 in the shape of a flange extending radially outward from the top of the upper portion 776. The first film 877a (also referred to as a base or bottom) can be attached to the bottom of the lower portion 772, the second film 877b (also referred to as a pierceable separator or partition) can be attached to the lip 775, and the third film 779 can be attached to the rim 778. Thus, the first film 877a, the lower portion 772, and the second film 877b can define a first chamber 871a of the dual-chamber beverage pod 770. The second film 877b, the upper portion 776, and the third film 779 can define a second chamber 871b of the dual-chamber beverage pod 770.

Each of the first, second, and third films 877a, 877b, 779 can be integrally formed with the sidewalls of the lower portion 772 or the upper portion 776. One or more of the first or second films 877a, 877b can have anti-agglomerating features. U.S. application Ser. No. 17/375,884 entitled BEVERAGE POD FOR AGGLOMERATING MATERIAL, filed Jul. 14, 2021, discloses frangible elements, filter elements, breaking away, and additional features that can be incorporated into the pods disclosed herein. U.S. application Ser. No. 17/375,884 is incorporated by reference in its entity. For example, the one or more of the first or second films 877a, 877b can have break-away flaps that cover the needles'(e.g., the needles 250, 260) opening when broken to allow a powder to fall from out of the first chamber 871a via an opening under the articulated break-away flap. Pressure exerted by a needle (e.g., an outlet pin) of a beverage making machine and a force of compression by closing the top of a beverage brewing chamber lid, like lid 104 of FIG. 1, can deform and break the beverage pod 770 along one or more breakaway lines of, for example, the first film 877a. In some instances, the beverage pod body is comprised of PLA and incudes a radial breakaway that is no more than 0.5 mm thick while the beverage pod bottom (e.g., the first film 877 a) is at least 2 mm thick. In another instance, the beverage pod bottom is comprised of PLA, a radial hinge is no less than 0.5 mm and no more than 1 mm, and the beverage pod may be at least 2 mm thick. Alternatively, the radial breakaway may comprise perforations on the first film 877a. In alternate embodiments, a radial breakaway may instead be comprised of an adhesive or pod bond between at least two adjacent beverage pod bottom segments.

The beverage pod 770 may include an agitation device such that the flow of brewing fluid is redirected when it contacts the agitation device, improving the mixing of the soluble beverage material with the brewing fluid and reducing agglomeration of the beverage material. The agitation device may be a feature of the first film 877a or a discrete component separate from the first film 877a. In some embodiments, the first film 877a may be a discrete component which may be mechanically or chemically bonded to the pod exterior using any of adhesives, heat sealing, ultrasonic welding, etc. The discrete first film 877a or parts of the first film 877a may be comprised of the same material as other parts of the beverage pod exterior. In some embodiments, the first film 877a may be made of different materials than the pod exterior side portions. Increased agitation combined with escaping of a beverage making material from a beverage pod are features that help produce an improved beverage as compared to the use of conventional beverage pods that do not include built in agitation features or openings that allow beverage making materials to escape a beverage pod. This is because the increased agitation improves solubility and because most or all of the beverage making material will be introduced into a person's cup rather than remaining in a conventional beverage pod.

The beverage pod 770 can be hold agglomerating materials such as nutraceutical material (e.g., Collagen protein) as the material might not have rapid solubility, especially in hot beverages, and moreover, the material is expensive compared to other types of soluble beverage material (e.g., cocoa), making the cost of failure much higher. These materials tend to agglomerate when exposed to fluids which can prevent the beverage material from exiting the beverage pod 770 through the narrow opening of a needle. The anti-agglomerating features can be used to bypass the needle, thereby inhibiting or preventing clogging of the needle.

In some embodiments, each of the first, second, and third films 877a, 877b, 779 can be a monolayer film or multi-layer film attached via welding (e.g., thermal welding, ultrasonic welding), adhesives, or other coupling mechanisms. In some embodiments, the lower portion 772 and the upper portion 776 are formed separately (e.g., using different injection mold apparatuses) and attached together, such as via thermal welding or ultrasonic welding. In some embodiments, the lower portion 772 and the upper portion 776 are integrally formed (e.g., using a single injection mold apparatus). The composition, number of layers, and configuration of the films 877a, 877b, 779 can be selected based on the desired sealing of the internal chambers.

FIG. 9 is a cutaway view of the dual-chamber beverage pod 770 disposed in the pod holder 210. The third membrane 779 can comprise a lidding material and is omitted for illustrative purposes only. As shown, the dual-chamber beverage pod 770 is sized such that when the rim 778 is placed on the rim 240, the second film 877b is placed on the lip 232, and the first film 877a is placed generally over the bottom portion 222. In particular, the outer surface of the dual-chamber beverage pod 770 generally tracks or corresponds to the inner surface of the pod holder 210 such that the volume of the beverage pod 770 is maximized for storing ingredients.

In operation, a user can push the beverage pod 770 into the pod holder 210 (e.g., by pushing down the lid 104 of the beverage brewing machine 102) such that the first needle 250 pierces the first film 877a and the second needle 260 pierces both the internal terminal end 873 and the second film 877b. The groove 774 can be a brew pin-receiving shoulder. Thus, the ingredients in the second chamber 871b can flow through the second needle 260 and into the first chamber 871a along flow path F1 (see FIGS. 5 and 9). In some embodiments, when the brewing pin 260 passes upwardly through the pin-receiving shoulder 873 and the separator 877b, liquid mixes with the beverage material (not shown) in the second chamber 871b to form a first beverage, which can flow downwardly through the needle 260, along the gap 777, and into the first chamber 871a to mix with the second beverage material to form a second beverage (not shown). In some embodiments, the ingredients in the first chamber 871a (which can include the ingredients from the second chamber 871b) can flow through the first needle 250 and out of the pod holder 210 via the opening 223 and/or the first needle 250 along flow path F2 (see FIG. 6). Thus, in some embodiments, the dual-chamber beverage pod 770 can have a self-cleaning feature in which the second chamber 871b can “flush” the first chamber 871a.

As discussed above, the first chamber 871a and the second chamber 871b can store different ingredients such that the pod holder 210 and the dual-chamber beverage pod 770 can be used to prepare a multi-ingredient beverage in a single step. For example, the first chamber 871a can store at least one of sugar, dairy products, or non-diary alternative products while the second chamber 871b stores coffee blend. The beverage materials can include, without limitation, coffee grounds, tea, or ingredients (e.g., soluble ingredients) for a mixed beverage such as hot chocolate. Beverage material may include any flavorings, nutritional content (e.g., any oils, nutritional supplements, active ingredients such as pharmaceuticals, cannabinoids, etc.), alcohol, coloring, or any other composition which effects on the final beverage. Each of the first chamber 871a and/or the second chamber 871b can store one or more ingredients. Depending on the characteristics of the ingredients, the ingredients can mix or not mix within the first chamber 871a. In some embodiments, the beverage pod 770 can be configured to sanitize components of the pod holder 210. The first chamber 871a can hold coffee grounds and the second chamber 871b can hold one or more additives, such as dairy products (e.g., creamer), sugar, syrups, etc. The first chamber 871a and the second chamber 871b can be sequentially or concurrently punctured to allow mixing of the beverage materials. The beverage brewing machine can deliver heated liquid into the first chamber 871a such that the heated liquid sanitizes, disinfects, pasteurizes, and/or cleans components, such as puncturing elements (e.g., needles 250, 260). The temperature of the liquid can be selected based on the brewing period. For example, water at a temperature equal to or higher than 90 degrees Celsius, 95 degrees Celsius, 100 degrees Celsius, 105 degrees Celsius, 110 degrees Celsius can be intermittently or continuously delivered into the beverage pod 770 for the brewing period (e.g., 30 seconds, 45 seconds, 1 minute, 90 seconds). The heated water can clean and/or sanitize puncturing elements, leaving the post-brewed puncturing element substantially free from, for example, bacteria. The temperature of the brewing liquid, brewing period, and beverage materials can be selected to achieve self-cleaning, self-sanitization, etc.

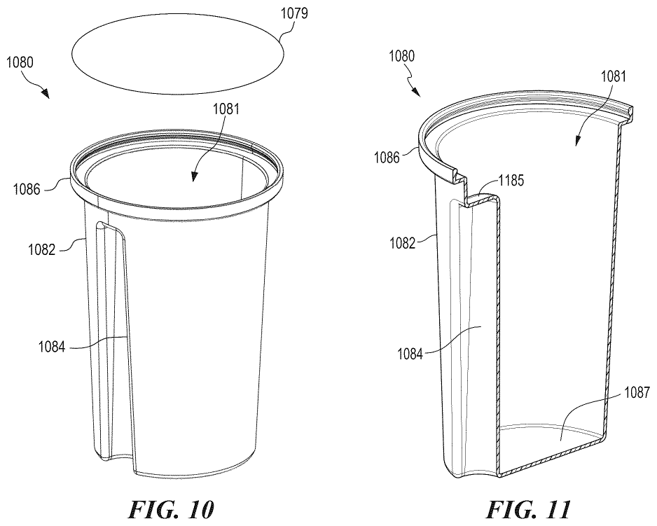

FIG. 10 is an isometric view of a single-chamber beverage pod 1080 configured in accordance with embodiments of the present technology. FIG. 11 is a cutaway view of the single-chamber beverage pod 1080. The description of components of the double-chamber beverage pod 770 of FIGS. 7-9 applies equally to the single-chamber beverage pod 1080. Referring to FIGS. 10 and 11 together, the beverage pod 1080 can include a body portion 1082 having a groove 1084 and a rim 1086, a first film 1087, and a second film 1079. The groove 1084 can extend from the bottom of the beverage pod 1080 towards, but not reaching, the rim 1086. The rim 1086 can extend radially outward and/or upward to provide surface area to which the second film 1079 can attach. The body portion 1082, the first film 1087, and the second film 1079 can define a chamber 1081 in which one or more ingredients can be stored.

The single-chamber beverage pod 1080 can be sized and shaped to fit in the lower portion 220 of the pod holder 210 (FIG. 2A). For example, the rim 1086 can be positioned on the lip 232 such that the first needle 250 pierces the first film 1087 and the second needle 260 pierces both a terminal end 1185 (FIG. 11) of the groove 1084 and the second film 1079. Therefore, the first needle 250 can provide a pathway for the ingredients stored in the chamber 1081 to flow out of the beverage pod 1080 and the pod holder 210, while the second needle 260 provides ventilation.

Therefore, the pod holder 210 is not limited to supporting dual-chamber beverage pods (e.g., the dual-chamber beverage pod 770), and can also support single-chamber beverage pods (e.g., the single-chamber beverage pod 1080). In some embodiments, the user can use the beverage pod 770 and the beverage pod 1080 sequentially to produce more complicated or specialty drinks. For example, the single-chamber beverage pod 1080 can store alcohol or other ingredient that ideally is dispensed into the cup before or after other ingredients.

### III. Manufacturing System

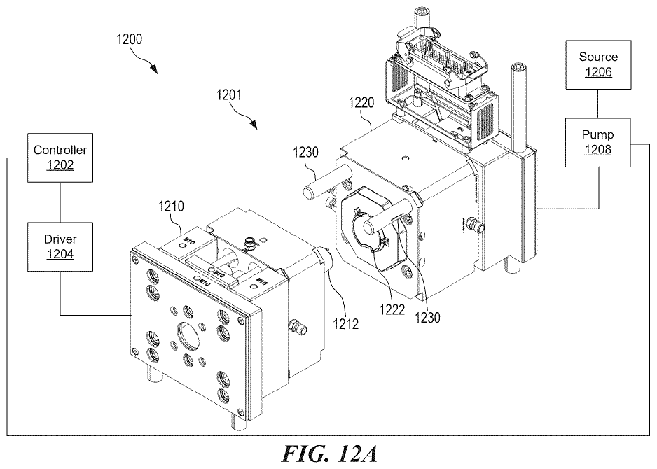

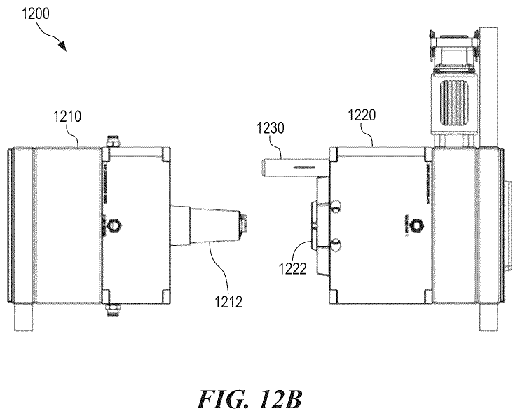

FIGS. 12A and 12B are isometric and side views, respectively, of a manufacturing system 1200 configured in accordance with embodiments of the present technology. The manufacturing system 1200 (“the system 1200”) can be an injection molding system 1200. It is appreciated that the system 1200 can be used to form the pod holder 210 illustrated in FIGS. 2A-6. The system 1200 can include a controller 1202, a driver 1204, a source 1206, a feed or pump 1208, and an injection molding apparatus 1201. The injection molding apparatus 1201 can include a positive molding part 1210 and a negative molding part 1220. The positive molding part 1210 can be, for example, a core, a mandrel, an elongated part configured to from an interior of a chamber.

The controller 1202 can be operably coupled to the driver 1204 and the pump 1208 to control operation thereof. The controller 1202 can include one or more processors, memories, communication devices, and/or input/output (I/O) devices. The processors can communicate with the I/O devices, which can include a display for display text and graphics and/or receiving inputs such as touch-based inputs or inputs from an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices can also be coupled to the processor, such as a network card, video card, audio card, USB, firewire or other external device, camera, printer, speakers, CD-ROM drive, DVD drive, disk drive, or Blu-Ray device.

The communication devices can be capable of communicating wirelessly or wire-based with a network node. The communication devices can communicate with another device or a server through a network using, for example, TCP/IP protocols. The controller 1202 can utilize the communication devices to distribute operations across multiple network devices.

The processors can have access to the memory in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory can include program memory that stores programs and software, such as an operating system, automatic query system, and other application programs. The memory can also include data memory, e.g., table data, column data, value filter data, user interface data, database element data, selection data, root table data, code snippet data, join query data, query template data, connection data, configuration data, settings, user options or preferences, etc., which can be provided to the program memory or any element of the controller 1202.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

The driver 1204 can include one or more actuators (e.g., linear actuator), motors (e.g., stepper motors, drive motors, etc.), hydraulic systems, or other component for moving the positive molding part 1210 towards or away from the negative molding part 1220. The source 1206 can store one or more polymers (e.g., polypropylene, resin) or other material suitable for forming by the system 1200. The polymers can be thermoplastic polymers, such as polypropylene (PP), polyethylene (PE), or polystyrene (PS). This allows it to serve as a biodegradable alternative for coffee pods. In some examples, the pod exterior can also be made from polyhydroxyalkanoates (PHAs), which are a biodegradable polyester produced through bacterial fermentation of sugar or lipids. The pod exterior can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage pod. PLLA is also readily renewable, often made from fermented plant starch such as from corn, cassava, sugarcane, or sugar beet pulp. Cellulose fibers are fibrous materials made from plant materials such cotton, flax, wood pulp, etc. Cellulose fibers can provide a biodegradable filter material that could be used in coffee pods. Other materials that are biodegradable plastic alternatives include petroleum-based plastics such as, Polyglycolic acid (PGA), Polybutylene succinate (PBS), Polycaprolactone (PCL), Polyvinyl alcohol (PVOH), and/or Polybutylene adipate terephthalate (PBAT). The injection molding system 1200 can form pods, beverage capsules, and components made, in whole or in part of, materials disclosed in U.S. application Ser. No. 17/327,330 (US Pub. No. 20210362941) filed May 5, 2021; U.S. application Ser. No. 17/570,188 (US Pub. No. 20220234773) filed Jan. 6, 2022; U.S. application Ser. No. 17/748,995 (US Pub. No. 20230110106) filed May 19, 2023, which are incorporated by reference in their entireties.

The source 1206 may also include a heater for keeping the polymer or other material in a liquid polymer state. The source 1206 can include, for example, one or more hoppers. The feed or pump 1208 (“pump 1208”) can include one or more drive mechanisms (e.g., one or more barrels, injection rams, reciprocating screws, motors, gearing, etc.), heaters, runners, etc. and can be coupled to transfer the polymer or other material from the source 1206 into the negative molding part 1220. As aforementioned, the controller 1202 can control the driver 1204 to move the positive molding part 1210 in a desired direction at a desired rate, and can control the pump 1208 to transfer a desired quantity of the polymer or other material from the source 1206 to the negative molding part 1220 at a desired flow rate, pressure, etc.

Referring to FIGS. 12A and 12B together, the positive molding part 1210 can include a tapered component 1212, and the negative molding part 1220 can include a tapered cavity 1222 and one or more alignment features 1230. In the illustrated embodiment, the alignment features 1230 comprised cylindrical protrusions that extend from the negative molding part 1220 towards the positive molding part 1210, which can include corresponding apertures (not shown) for receiving the cylindrical protrusions. In other embodiments, the alignment features 1230 can comprise other geometries and/or alternatively or additionally extend from the positive molding part 1210.

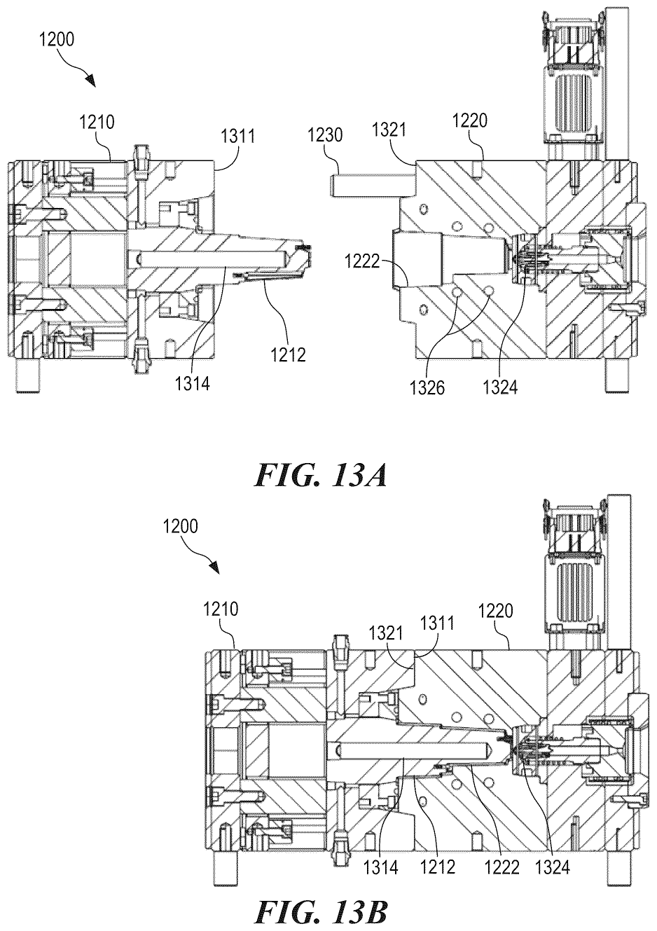

FIGS. 13A and 13B are side cross-sectional views of the system 1200 in an open state and a closed state, respectively. Referring to FIGS. 13A and 13B together, the positive molding part 1210 can include a first contact surface 1311 and the negative molding part 1220 can include a second contact surface 1321 facing the first contact surface 1311. The positive molding part 1210 can include a channel or recess 1314 for receiving or circulating a coolant therein. The negative molding part 1220 can also include a gate 1324 for receiving the polymer or other material and one or more channels 1326 for circulating the coolant therein.

In operation, the controller 1202 (FIG. 12A) can control the pump 1208 to transfer the polymer or other material in a liquid state into the tapered cavity 1222 via the gate 1324, which is in fluid communication with the space defined by the tapered cavity 1222. The controller 1202 can also control the driver 1204 to move the positive molding part 1210 towards negative molding part 1220, thus configuring the system 1200 from the open state (FIG. 13A) to the closed state (FIG. 13B). In the open state, gaps are present around the tapered cavity 1222 to allow air to escape while facilitating flow of the melted polymer along complex flow paths. More specifically, the driver 1204 can move the positive molding part 1210 until the first contact surface 1311 contacts the second contact surface 1321. When the first and second contact surfaces 1311, 1321 are in contact, as shown in FIG. 13B, there can be a gap between the tapered component 1212 and the tapered cavity 1222. The gap can define the shape for forming, for example, the pod holder 210. For example, as shown, the tapered component 1212 and the tapered cavity 1222 are shaped so as to define a lower portion, a lip, an upper portion, etc. of the pod holder. In some embodiments, a first needle (e.g., the first needle 250) and a second needle (e.g., the second needle 260) can be attached to the tapered component 1212 such that the polymer or other material can flow into contact with and around the needles. The coolant flowing in the channels 1314, 1324 can then cool and solidify the polymer or other material to the shape defined by the gap between the tapered component 1212 and the tapered cavity 1222.

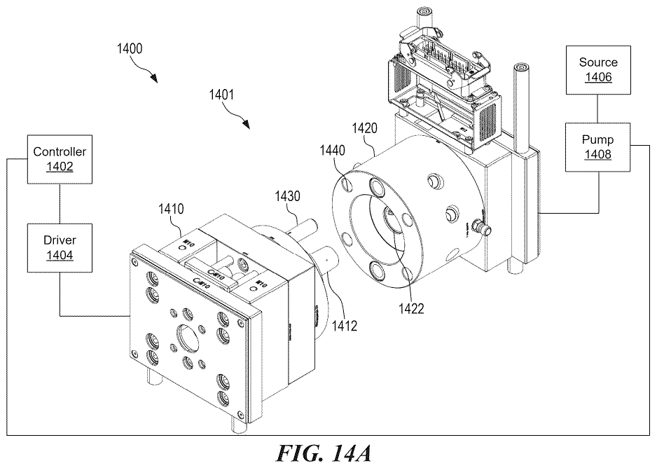

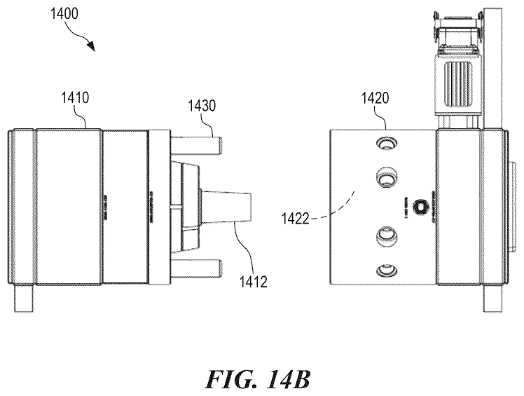

FIGS. 14A and 14B are isometric and side views, respectively, of another injection molding system 1400 (“the system 1400”) configured in accordance with embodiments of the present technology. It is appreciated that the system 1400 can be used to form the lower portion 772 of the dual-chamber beverage pod 770 illustrated in FIGS. 7 and 8. The system 1400 can include a controller 1402, a driver 1404, a source 1406, a pump 1408, and an injection molding apparatus 1401. The injection molding apparatus 1401 can include a positive molding part 1410 and a negative molding part 1420.

The controller 1402 can be operably coupled to the driver 1404 and the pump 1408 to control operation thereof. The controller 1402 can be generally similar to the controller 1202 in structure and function, as described above with reference to FIG. 12A. The driver 1404 can include an actuator (e.g., a linear actuator), a motor, hydraulics, or other component for moving the positive molding part 1410 towards or away from the negative molding part 1420. The source 1406 can store polymer (e.g., polypropylene) or other material suitable for forming by the system 1400. The source 1406 may also include a heater for keeping the polymer or other material in a liquid polymer state. The pump 1408 can be coupled to transfer the polymer or other material from the source 1406 into the negative molding part 1420. As aforementioned, the controller 1402 can control the driver 1404 to move the positive molding part 1410 in a desired direction at a desired rate, and can control the pump 1408 to transfer a desired quantity of the polymer or other material from the source 1406 to the negative molding part 1420 at a desired flow rate, pressure, etc.

Referring to FIGS. 14A and 14B together, the positive molding part 1410 can include a tapered component 1412, and the negative molding part 1420 can include a tapered cavity 1422 and one or more alignment features 1430. In the illustrated embodiment, the alignment features 1430 comprised cylindrical protrusions that extend from the negative molding part 1420 towards the positive molding part 1410, which can include corresponding apertures (not shown) for receiving the cylindrical protrusions. In other embodiments, the alignment features 1430 can comprise other geometries and/or alternatively or additionally extend from the positive molding part 1410.

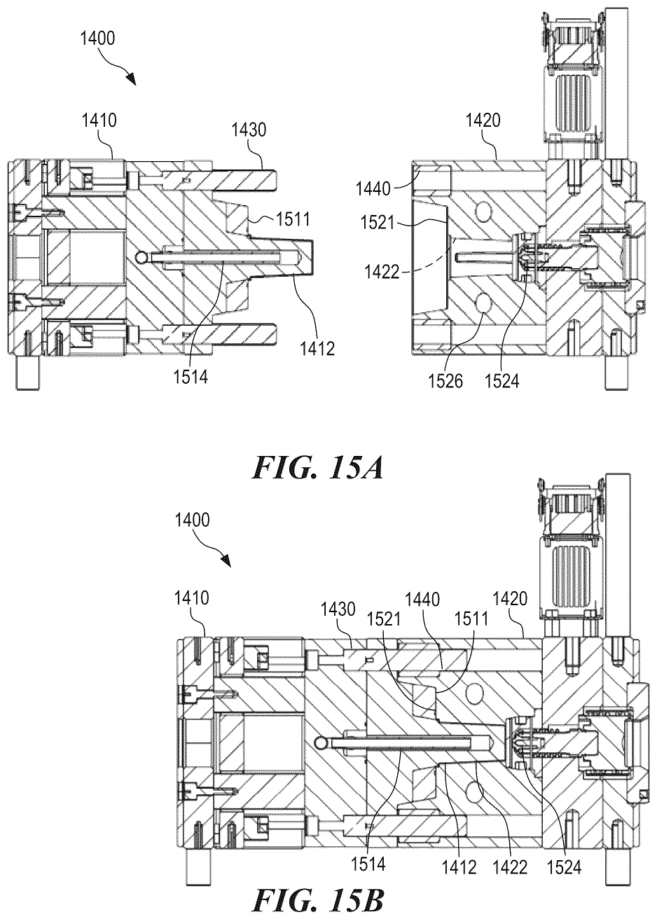

FIGS. 15A and 15B are side cross-sectional views of the system 1400 in an open state and a closed state, respectively. Referring to FIGS. 15A and 15B together, the positive molding part 1410 can include a first contact surface 1511 and the negative molding part 1420 can include a second contact surface 1521 facing the first contact surface 1511. The positive molding part 1410 can include a channel or recess 1514 for receiving or circulating a coolant therein. The negative molding part 1420 can also include a gate 1524 for receiving the polymer or other material and one or more channels 1526 for circulating the coolant therein.

In operation, the controller 1402 (FIG. 14A) can control the pump 1408 to transfer the polymer or other material in a liquid state into the tapered cavity 1422 via the gate 1524. The controller 1402 can also control the driver 1404 to move the positive molding part 1410 towards negative molding part 1420, thus configuring the system 1400 from the open state (FIG. 15A) to the closed state (FIG. 15B). More specifically, the driver 1404 can move the positive molding part 1410 until the first contact surface 1511 contacts the second contact surface 1521. When the first and second contact surfaces 1511, 1521 are in contact, as shown in FIG. 15B, there can be a gap between the tapered component 1412 and the tapered cavity 1422. The gap can define the shape for forming, for example, the lower portion 772 of the beverage pod 770. For example, as shown, the tapered component 1412 and the tapered cavity 1422 are shaped so as to define a groove, a lip, etc. of the beverage pod. The coolant flowing in the channels 1514, 1524 can then cool and solidify the polymer or other material to the shape defined by the gap between the tapered component 1412 and the tapered cavity 1422.

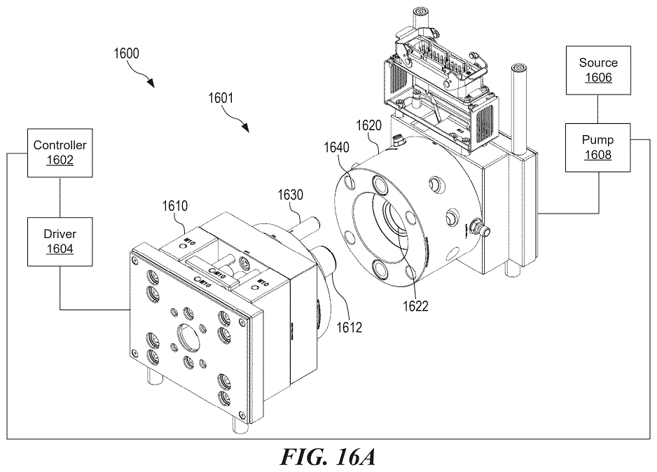

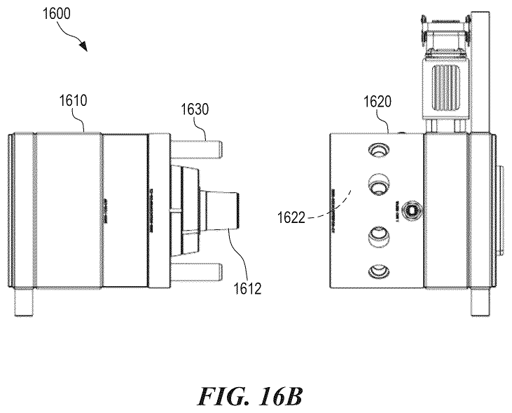

FIGS. 16A and 16B are isometric and side views, respectively, of yet another injection molding system configured in accordance with embodiments of the present technology. It is appreciated that the system 1600 can be used to form the upper portion 776 of the dual-chamber beverage pod 770 illustrated in FIGS. 7 and 8. The system 1600 can include a controller 1602, a driver 1604, a source 1606, a pump 1608, and an injection molding apparatus 1601. The injection molding apparatus 1601 can include a positive molding part 1610 and a negative molding part 1620.

The controller 1602 can be operably coupled to the driver 1604 and the pump 1608 to control operation thereof. The controller 1602 can be generally similar to the controller 1202 in structure and function, as described above with reference to FIG. 12A. The driver 1604 can include an actuator (e.g., a linear actuator), a motor, hydraulics, or other component for moving the positive molding part 1610 towards or away from the negative molding part 1620. The source 1606 can store polymer (e.g., polypropylene) or other material suitable for forming by the system 1600. The source 1606 may also include a heater for keeping the polymer or other material in a liquid polymer state. The pump 1608 can be coupled to transfer the polymer or other material from the source 1606 into the negative molding part 1620. As aforementioned, the controller 1602 can control the driver 1604 to move the positive molding part 1610 in a desired direction at a desired rate, and can control the pump 1608 to transfer a desired quantity of the polymer or other material from the source 1606 to the negative molding part 1620 at a desired flow rate, pressure, etc.

Referring to FIGS. 16A and 16B together, the positive molding part 1610 can include a tapered component 1612, and the negative molding part 1620 can include a tapered cavity 1622 and one or more alignment features 1630. In the illustrated embodiment, the alignment features 1630 comprised cylindrical protrusions that extend from the negative molding part 1620 towards the positive molding part 1610, which can include corresponding apertures (not shown) for receiving the cylindrical protrusions. In other embodiments, the alignment features 1630 can comprise other geometries and/or alternatively or additionally extend from the positive molding part 1610.

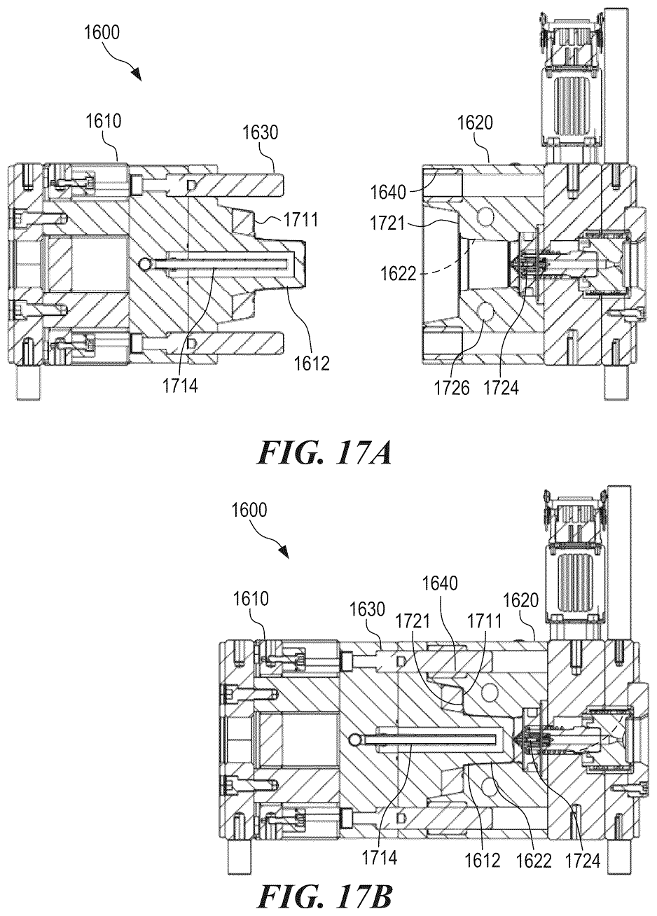

FIGS. 17A and 17B are side cross-sectional views of the system 1600 in an open state and a closed state, respectively. Referring to FIGS. 17A and 17B together, the positive molding part 1610 can include a first contact surface 1711 and the negative molding part 1620 can include a second contact surface 1721 facing the first contact surface 1711. The positive molding part 1610 can include a channel or recess 1714 for receiving or circulating a coolant therein. The negative molding part 1620 can also include a gate 1724 for receiving the polymer or other material and one or more channels 1726 for circulating the coolant therein.

In operation, the controller 1602 (FIG. 16A) can control the pump 1608 to transfer the polymer or other material in a liquid state into the tapered cavity 1622 via the gate 1724. The controller 1602 can also control the driver 1604 to move the positive molding part 1610 towards negative molding part 1620, thus configuring the system 1600 from the open state (FIG. 17A) to the closed state (FIG. 17B). More specifically, the driver 1604 can move the positive molding part 1610 until the first contact surface 1711 contacts the second contact surface 1721. When the first and second contact surfaces 1711, 1721 are in contact, as shown in FIG. 17B, there can be a gap between the tapered component 1612 and the tapered cavity 1622. The gap can define the shape for forming, for example, the upper portion 776 of the beverage pod 770. For example, as shown, the tapered component 1612 and the tapered cavity 1622 are shaped so as to define a rim, etc. of the beverage pod. The coolant flowing in the channels 1714, 1724 can then cool and solidify the polymer or other material to the shape defined by the gap between the tapered component 1612 and the tapered cavity 1622.

After the system 1400 (FIGS. 14A-15B) forms the lower portion 772 and the system 1600 (FIGS. 16A-17B) forms the upper portion 776, the formed lower and upper portions 772, 776 can be extracted from their respective injection molding systems. Then, one or more films can be attached to each of the lower and upper portions 772, 776. Afterwards, the lower and upper portions 772, 776 can be attached together (e.g., via thermal welding, ultrasonic welding, snap-fitting, etc.) to form the completed dual-chamber beverage pod 770. Forming the lower portion 772 and the upper portion 776 separately can be advantageous by, for example, allowing the second film 877b to be attached to the lower portion 772 (or the upper portion 776) more easily. In some embodiments, however, a different injection molding system can be used to form the dual-chamber beverage pod as a whole in which the lower and upper portions 772, 776 are integrally formed.

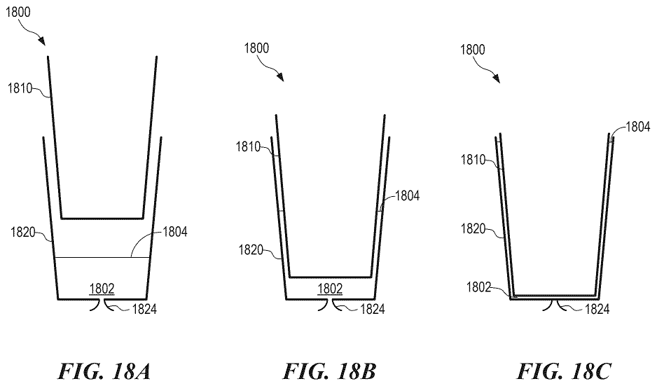

FIGS. 18A-18C illustrate an injection molding process in accordance with embodiments of the present technology. It is appreciated that the process illustrated in FIGS. 18A-18C can be used in operation of the system 1200, the system 1400, and/or the system 1600. Referring first to FIG. 18A, an injection molding system 1800 (“the system 1800”) includes liquid polymer 1802 (or other molding material) pumped into a tapered cavity 1820 via one or more gates 1824 and pooled therein, forming a surface level 1804. In some embodiments, a single liquid polymer is injected into the cavity 1820. In some embodiments, multiple polymers are co-injected to product multi-layer articles (e.g., preforms, pods, baskets, etc.). The layers can include, without limitation, one or more barrier layers, such as oxygen barrier layers, vapor barrier layers, passive barrier layers, active barrier layers (e.g., oxygen scavenger layers), etc. The oxygen barrier layers is selected from the group consisting of polyethylene naphthalate (PEN), ethylene vinyl alcohol (EVOH), polyvinyl alcohol (PVOH), polyvinylidene chloride (PVDC), polyacrylonitrile (PAN), and liquid crystal polymer (LCP). In some embodiments, one or more polymers are injected via a gate of the tapered component 1810 while injecting one or more polymers via the gate(s) 1824. The tapered component 1810 is positioned away from the surface level 1804, defining an open state of the system 1800.

Referring next to FIG. 18B, the tapered component 1810 is moved towards and further into the tapered cavity 1820, thereby being at least partially submerged in the liquid polymer 1802. Therefore, the polymer 1802 flows around the tapered component 1810 and the surface level 1804 rises. FIG. 18B illustrates intermediate relative positions of the tapered component 1810 and the tapered cavity 1820 when the system 1800 is in between the open state and a closed state.

Referring next to FIG. 18C, the tapered component 1810 is moved even further into the tapered cavity 1820. The polymer 1802 thus continues to flow around the tapered component 1810 and the surface level 1804 rises more. FIG. 18C illustrates the final relative positions of the tapered component 1810 and the tapered cavity 1820 when the system 1800 is in the closed state.

By pooling the polymer 1802 prior to moving the tapered component 1810 into the tapered cavity 1820, the system 1800 can form components (e.g., the pod holder 210, the dual-chamber beverage pod 770) having relatively thin thicknesses using relatively viscous liquid polymers. For example, pushing the tapered component 1810 into the polymer 1802 can induce the polymer 1802 to flow evenly around the tapered component 1810. By contrast, configuring the system 1800 in the closed state (FIG. 18C), then injecting the liquid polymer 1802 into the gap between the tapered component 1810 and the tapered cavity 1820 can cause the polymer 1802 to fail to flow in the relatively narrow gap to form the desired relatively thin thickness, particularly if the liquid polymer 1802 is relatively viscous. The closing of the system 1800 can apply pressure significantly more (e.g., at least 150%, 200%, 300%, or 400%) than the injection pressure at the gate.

Any of the injection molding systems described herein (e.g., the systems 1200, 1400, 1600, 1800) can be configured for molding, forming, and annealing an article of manufacture using a series of molds. U.S. application Ser. No. 17/694,342 (US Pub. No. 20220288828) discloses systems, methods, and features that can be used with or incorporated into the system 1600, and U.S. application Ser. No. 17/694,342 (US Pub. No. 20220288828) is incorporated by reference in its entirety. For example, the system may melt degradable thermoplastic materials that are then injected into a first mold to form an article of manufacture. This article may then be moved to a second mold where the formed article is annealed. The second mold may be heated based on operation of a heating element that heats the annealing mold reservoirs of fluids that may be used to heat and/or cool articles such as beverage pods during an annealing process. This annealing process may condition materials in the formed article to enhance properties of the article. For example, annealing may improve thermal resistance of the article. The system may employ two molds, one mold that forms articles and a second mold that anneals articles to facilitate a continuous production of beverage pods using environmentally friendly materials. The system may employ two or more molds for performing overmolding.

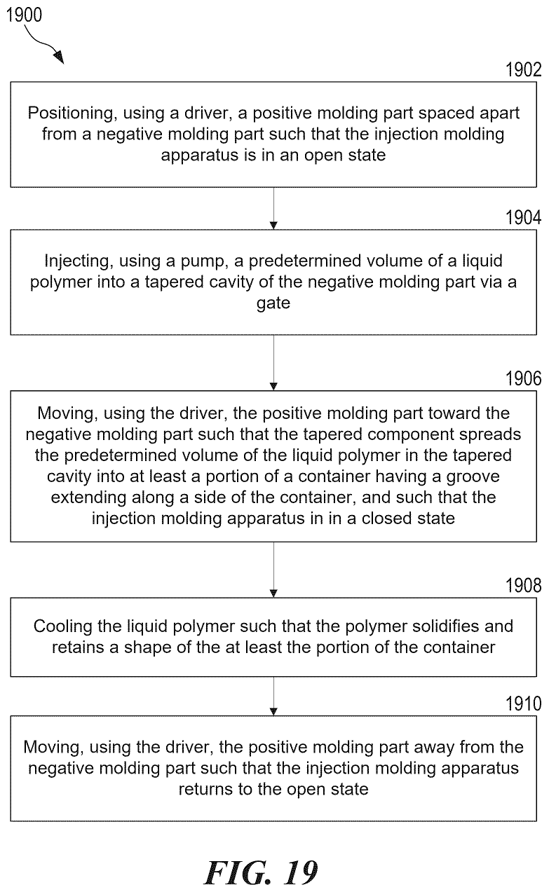

FIG. 19 is a flowchart illustrating a method 1900 of operating an injection molding system in accordance with embodiments of the present technology. It is appreciated that the method 1900 can be an example method for operating the system 1200, the system 1400, the system 1600 and/or other injection molding systems. Also, while the steps of the method 1900 are presented below in a particular order, one of ordinary skill in the art will appreciate that one or more steps can be performed in a different order or omitted, and that the method 1900 can include additional and/or alternative steps.

The method 1900 begins at block 1902 by positioning, using a driver (e.g., the driver 1204), a positive molding part (e.g., the positive molding part 1210) spaced apart from a negative molding part (e.g., the negative molding part 1220) such that an injection molding apparatus (e.g., the injection molding apparatus 1201) is in an open state.

In some embodiments, a thermoplastic material such as polylactic acid (PLA) or other materials discussed above is in a melting apparatus that may include a hopper. The forming material may be stored in this hopper. An apparatus may be used to move the forming material to the melting apparatus. An example of a moving apparatus is a belt feeder. The forming material may be a biodegradable or compostable thermoplastic. The melting apparatus may heat the forming material to a temperature where the material melts. This may include use of a heating unit such as a furnace or a heating coil. For example, the apparatus may heat the PLA to a temperature of 170 degrees Celsius to melt the forming material.

After the forming material is melted, it may be injected into a forming mold via a gate (e.g., the gate 1324 discussed at block 1904 of method 1900 of FIG. 19). An apparatus that feeds melted material to an injection nozzle may be a screw feeder that mixes the melted forming material in a manner that maintains a uniformity of the melted forming material. This injection process may use high-pressure components to inject the melted forming material into the forming mold. This may include injecting the melted material into the cavity side and/or the core side of the mold. This may facilitate the forming of the melted material into a shape of an article.

At block 1904, the method 1900 continues by injecting, using a pump (e.g., the pump 1208), a predetermined volume of a liquid polymer (e.g., the polymer 1802) into a tapered cavity (e.g., the tapered cavity 1222) via a gate (e.g., the gate 1324).

At block 1906, the method 1900 continues by moving, using the driver, the positive molding part toward the negative molding part such that the tapered component spreads the predetermined volume of the liquid polymer in the tapered cavity into at least a portion of a container (e.g., the pod holder 210, the lower portion 722 of the beverages pod 770) having a groove (e.g., the groove 224, the groove 774) extending along a side of the container, and such that the injection molding apparatus is in a closed state.

At block 1908, the method 1900 continues by cooling the liquid polymer (e.g., via circulating a coolant in channels 1314, 1326) such that the polymer solidifies and retains a shape of the at least the portion of the container.

At block 1910, the method 1900 continues by moving, using the driver, the positive molding part away from the negative molding part such that the injection molding apparatus returns to the open state.

In some embodiments, the method 1900 continues by operating a second injection molding apparatus to create another portion of the container (e.g., the upper portion 776 of the beverage pod 770), and the formed lower and upper portions can subsequently be attached (e.g., via thermal welding, ultrasonic welding).

After an article is formed, the article may be ejected from a forming mold cavity side. This may include separating from a core side from a cavity side of the forming mold. The ejection process may be facilitated using a pressurized gas (such as air). By introducing compressed air into the cavity side of the injection mold, the formed article may be freed from the forming mold. In instances, the article may be ejected from the forming mold core side after separating from the forming mold cavity side using an ejection plate that forces the article away from the core side of the forming mold. Once the formed article is ejected from the forming mold, it may be transferred to an annealing mold or further processing step. A transfer actuator may use a vacuum force to firmly hold the article after it has been ejected when the article is being moved to the annealing mold. In certain instances, a vacuum may also be used to remove the formed article from the forming mold. U.S. application Ser. No. 17/694,342 (US Pub. No. 20220288828) discloses molding processing, transfer actuators, heating, cooling, materials, processing temperatures, mold features, and technology usable with any of the injection molding systems described herein.

### IV. Beverage Brewing Systems

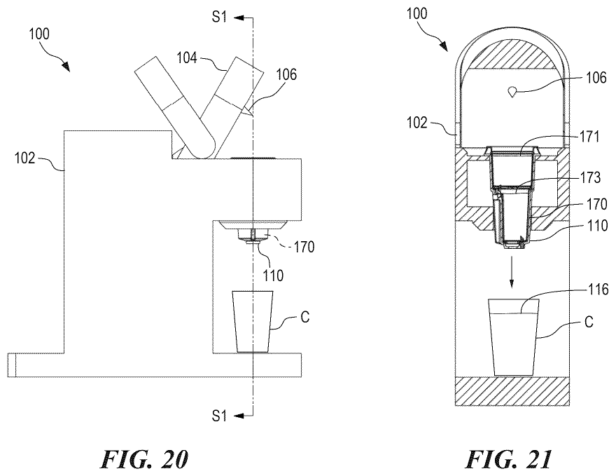

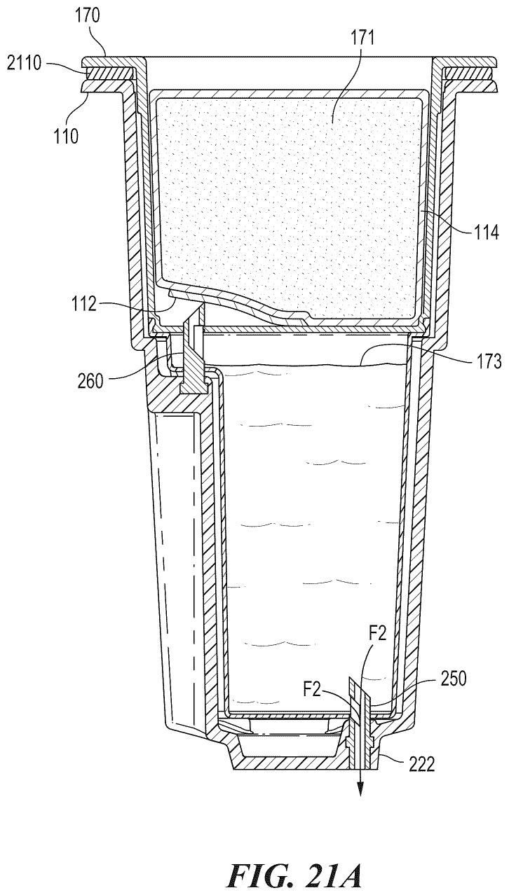

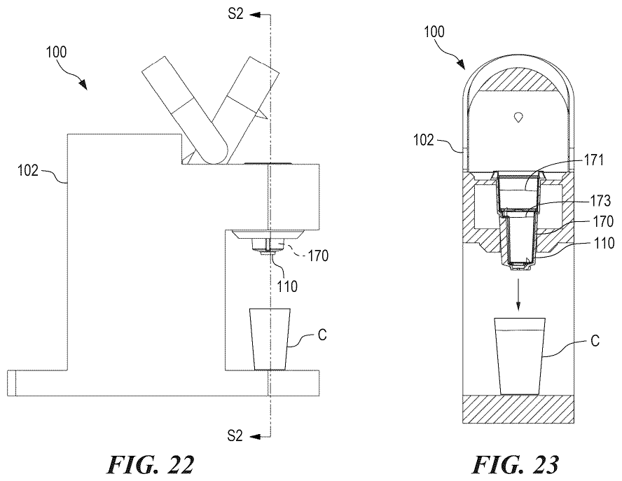

FIG. 20 is a side view of the beverage brewing system 100. FIG. 21 is a cross-sectional view of the beverage brewing system 100 taken along a first sectional plane S1-S1 shown in FIG. 20. The first sectional plane S1-S1 can correspond to a longitudinal plane of the pod holder 110 and/or the beverage pod 170. FIG. 22 is a side view of the beverage brewing system 100. FIG. 23 is a cross-sectional view of the beverage brewing system 100 taken along a second sectional plane S2-S2 shown in FIG. 22. The second sectional plane S2-S2 can correspond to a plane offset from but parallel to the longitudinal plane of the pod holder 110 and/or the beverage pod 170.

Referring to FIGS. 20-23 together, the beverage brewing system 100 includes the beverage pod 170 disposed inside the pod holder 110, which is disposed inside the beverage brewing machine 102. Both the beverage pod 170 and the pod holder 110 are positioned above a cup C placed on the beverage brewing machine 102. In operation, a user can close the lid 104 to push down on the beverage pod 170, causing the puncture element 106 to pierce a film (e.g., the third film 779) of the beverage pod 170, and first and second needles (e.g., the needles 250, 260) to pierce additional films (e.g., the first film 877a and the second film 877b, respectively). As shown in FIGS. 21 and 23, the positions of the first needle and the bottom opening are directly above the cup C such that the ingredients can flow into the cup C. The lower portion of the beverage pod 170 is configured to contain a sufficient amount of a first beverage material 173 that is at a temperature equal to or higher than a sanitization temperature (e.g., 90 degrees Celsius, 100 degrees Celsius, 110 degrees Celsius, 110 degrees Celsius, etc.) for lower brewing pin sanitization. In some sanitized brewing processes, the beverage pod 170 can contain a sufficient amount (e.g., 1 fluid ounce, 1.5 fluid ounces, 2 fluid ounces, 2.5 fluid ounces, 3 fluid ounces, 4 fluid ounces, etc.) of the heated liquid/beverage for brewing pin sanitization. For example, all or most of the beverage-contacting portions of the brewing pins contacting foodstuff (e.g., heated liquid, heated beverage, partially brewed beverage, etc.) can be submerged in the heated liquid/beverage, thereby sanitizing the beverage-contacting portions. The brewing pins can be partially or completely submerged for a sanitization period equal to or greater than at least 10 seconds, 20 seconds, 30 seconds, 45 seconds, 1 minute, 2 minutes, or the like. The lower portion of the beverage pod 170 can be configured to release substantially all (at least 70%, 80%, 90%, 95%, 98%, or 99% by weight or volume) of the contained beverage material prior to completion of delivery of the heated liquid into the beverage pod 170. In other embodiments, the beverage pod 170 can be used to perform non-sanitization brewing for cold or iced beverages.

In some embodiments, the beverage pod 170 includes coffee grounds 171 in the upper chamber, and a beverage liquid 173 (e.g., at least 1 fluid ounce, 1.5 fluid ounce, 2 fluid ounce, 3 fluid ounce, etc.) in the lower chamber. The coffee grounds 171 (e.g., all or most by weight) can remain in the upper chamber while the final beverage is released into the cup C. A filter or mesh can be positioned in the upper chamber to retain the coffee grounds in the upper chamber. The ratio of a first volume of the upper chamber to a second volume of the lower chamber is equal to or greater than 1, 2, 3, 4, etc. This allows for a relatively large volume of beverage material 173 to be released from the beverage pod 170 into the cup. In some embodiments, the ratio of the first volume of the upper chamber to a second volume of the lower chamber is equal to or less than 0.25, 0.5, 0.75, or 1. This allows for a relatively small volume of beverage material 173 to be released from the beverage pod 170 into the cup.

Referring now to FIGS. 21 and 21A, the beverage pod 170 can be a compostable pod that comprises at least one compostable gasket 2110. The compostable gasket 2110 may be, for example, a flat ring, similar in share to a mechanical washer, of cellulose fiber with a layer of PLA on one side of the flat ring. The side of the compostable gasket with a layer of PLA may be placed against the underside of the upper lip (e.g., rim or lip 778 of FIG. 8) of the beverage pod 170. The PLA side of the compostable gasket 2110 may then be fused to the upper portion (e.g., upper portion 776 of FIG. 8). In an exemplary embodiment, the compostable gasket 2110 is fused to the upper portion using ultrasonic welding. One or more filter guards 112, or faceplates, can be solid structures integrated into the beverage pod 170 that prevents the outlet piercing element from creating a path for the insoluble beverage material from inside the filter to the outlet. In some embodiments, the capsule interior may include integrated features to act as a filter guard, removing the requirement for a discrete component. Another element (not shown) can be positioned above the lower brewing pin.

The beverage pod 170 can include a capsule interior with integrated features to act as a filter guard, removing the requirement for a discrete filter guard 112. When the upper brewing pin passes through the beverage pod 170, it can contact the bottom side of the filter guard 112. The brewing pin can push the filter guard 112 upwardly to form a gap through which fluid can flow. For example, the brewing pin 260 of FIG. 9 can pass through the separator 877b of the upper portion 778 of FIG. 9. The filter guard 112 can be pushed away from the separator 877b to define a fluid path underneath the filter guard 112. The beverage in the upper chamber 871b can flow around and underneath the filter guard 112 and ultimately through the brewing pin 260, as indicated by F1 in FIG. 9. The lower portion of the beverage pod 170 can include the components discussed with respect to the upper portion.

A filter 114, disposed in the upper chamber 871b, can be a medium, such as spun bond PLA web, paper (cellulose), cloth or metal, that is used to prevent an insoluble beverage material from leaving the beverage pod and entering the beverage brewing machine or the beverage. The filter 114 can be symmetrical (e.g., fluted), or asymmetrical (e.g., pleated). Beverage material is the material used to produce a brewed beverage, such as coffee grounds, tea, or a mix beverage where the beverage material is soluble, such as hot chocolate. Beverage material may include any flavorings, nutritional content (e.g., any oils, nutritional supplements, active ingredients such as pharmaceuticals, cannabinoids, etc.), alcohol, coloring, or any other composition which has an effect on the final beverage 116 (FIG. 21). Beverage brewing machines for brewing portioned beverages from pre-packed beverage pods exist for a variety of beverages made from a beverage material that is either insoluble, such as coffee, or soluble, such as hot chocolate.

Each of the compartment portions of the beverage pod 170 can include auxiliary components. Example auxiliary components, features, and methods are disclosed in U.S. application Ser. No. 15/135,808 (US Pub. No. 20160325898); U.S. application Ser. No. 1515/414,587 (US Pub. No. 20180206667); U.S. application Ser. No. 15/589,743; U.S. application Ser. No. 17/369,641 (US Pub. No. 20210401219); U.S. application Ser. No. 17/375,884 (US Pub. No. 20220017294); PCT Pub. No. WO2021226582; PCT Pub. No. WO2022013792; U.S. application Ser. No. 17/316,135 (US Pub. No. 20210347558); U.S. application Ser. No. 17/323,431 (US Pub. No. 20210354405); U.S. application Ser. No. 17/327,330 (US Pub. No. 20210362941); U.S. application Ser. No. 17/344,541 (US Pub. No. 20210386237); U.S. application Ser. No. 17/346,934 (US Pub. No. 20210386236); U.S. application Ser. No. 17/570,189 (US Pub. No. 20220234774); U.S. application Ser. No. 17/570,188 (US Pub. No. 20220234773); U.S. application Ser. No. 17/570,182 (US Pub. No. 20220234772); U.S. application Ser. No. 17/694,285 (US Pub. No. 20220287494); and U.S. application Ser. No. 17/694,342 (US Pub. No. 20220288828); U.S. application Ser. No. 17/748,993 (US Pub. No. 20230111111); and U.S. application Ser. No. 17/748,995 (US Pub. No. 20230110106), which are all incorporated by reference in their entireties. The auxiliary components can include filter elements, plates, registration elements, etc. For example, the lower portion of the beverage pod 170 of FIGS. 21-21A can include the filter guard 112, filter elements, or the like. For example, the lower portion of the pod 170 can include one or more of the filter 114 (e.g., a planar filter, a bag filter, a mesh filter, etc.) that fits inside the interior chamber. One or more filter guards 112 can also be positioned to lay across the lower brewing pin 250. This allows for beverage materials to be retained in the lower portion. For example, the first beverage material 171 can be coffee grounds. The second beverage material 173 can be in the form of tea leaves. This allows for the coffee grounds and tea leaves to be retained in the beverage capsule pod 170 to brew a tea-infused coffee beverage. In other embodiments, the lower portion can release the second beverage material 173. For example, a liquid, a powder, or other beverage ingredient can be held in the lower portion. When the brewing needle 250 accesses the lower portion, the second beverage material 173 can fall unobstructed out of the lower portion. This allows for convenient releasing of most (e.g., most by volume or weight), substantially all, (e.g., substantially all by volume or weight), or the entire contents of the lower portion.

The beverage brewing machine 102 can contain many components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing machine contains all components necessary to accomplish the beverage brewing process, though specific reference to beverage brewing machine components may only be made to those components which come into direct contact with the beverage pod, such as the brewing chamber, a fluid injecting component, and a fluid extracting component. A beverage brewing machine can contain the following elements: A beverage brewing machine can contain the following elements: A fluid source that supplies the liquid, usually water, to the brewing machine for producing the desired beverage, element 120. A brewing chamber lid that opens to allow a new pod to be added to the machine, and in many of the most common embodiments of a beverage brewing machine, the chamber lid contacts the fluid source to the brewing pin, but the fluid source does not have to be in the brewing chamber lid, element 105. A brewing pin member, or fluid injecting component 106, that typically has a piercing element to puncture the beverage pod lid, that provides a liquid, typically hot water, to mix with the beverage medium to create the beverage.

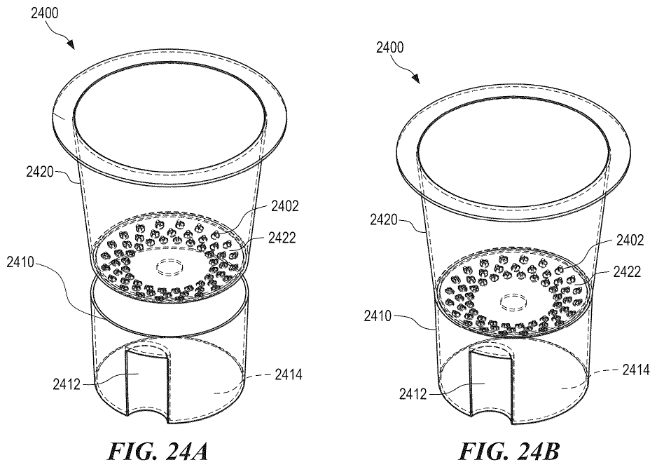

FIGS. 24A and 24B are isometric views of another beverage pod 2400 in a disassembled state and an assembled state, respectively, and configured in accordance with embodiments of the present technology. Referring to FIGS. 24A and 24B together, the beverage pod 2400 can include a lower portion 2410 and an upper portion 2420. The lower portion 2410 can include a first film 2414 at the bottom and a groove 2412 extending from the bottom towards, but not reaching, a top rim of the lower portion 2410. The upper portion 2420 can include a second film 2422 at the bottom of the upper portion 2420, and an upper flange to which another film (not shown) can be attached. In some embodiments, the second film 2422 can comprise a mesh for supporting tea leaves 2402 or other ingredients thereon. Therefore, when the beverage pod 2400 is in use, hot water can be poured into the upper portion 2420 to brew tea.

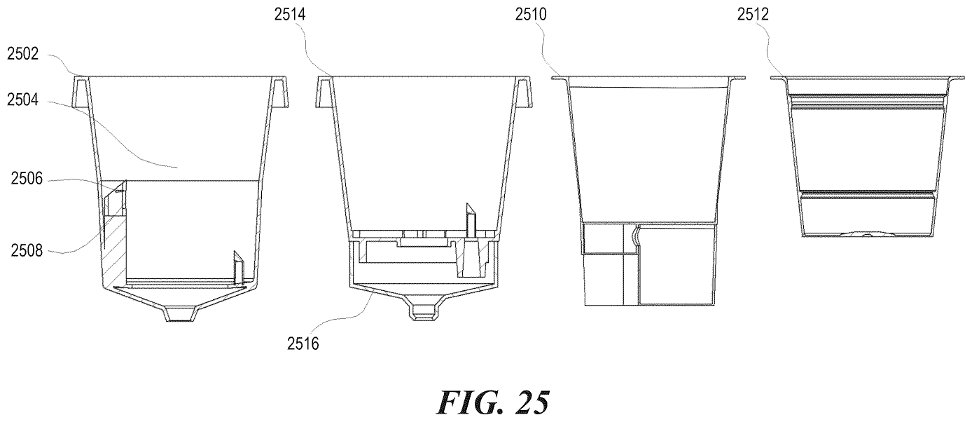

In some applications, the beverage brewing system 100 can be configured to accept a standard size beverage pod in a brew basket. The brew basket can be replaced a pod holder (e.g., pod holder 210 of FIG. 3), adaptive housing, or the like. FIG. 25 shows an adaptive housing 2502 designed as a retrofit to replace the standard brew basket in a single-serve beverage brewing machine. The adaptive housing 2502 may mimic the dimensions and form factor of the standard brew basket at specific contact points with the brewing machine, allowing for seamless integration into the brewing machine's structure without the necessity for modifications. For example, at least portions of the adaptive housing 2502 that contact the brewing machine can be geometrically congruent to the corresponding portions of the standard brew basket. The adaptive housing 2502 can be inserted into and removed from the brewing machine in a similar manner to the original brew basket, enabling installation and removal for maintenance or replacement. At least one distinguishing characteristic of the adaptive housing 2502 can be its increased internal cavity size in pod receptacle 2504, which is designed to accommodate a larger beverage pod. This enhancement over the standard brew basket provides the ability to use beverage pods that contain a greater quantity of brewing material or additional ingredients, thereby expanding the versatility of beverage creation. The internal cavity of the adaptive housing 2502 may secure a larger beverage pod and facilitate efficient extraction of the beverage. For example, the beverage pod can have a holding capacity at least 10%, 20%, 30%, 40%, 50%, 60%, or 100% greater than the beverage pod it replaces. The adaptive housing 2502 may incorporate an extraction facilitator 2506 and a beverage transfer channel 2508 for directing the flow of the brewed beverage to the output spout of the brewing machine. The design of the adaptive housing 2502 constitutes a significant advancement in the single-serve beverage brewing technology, offering potential for richer and more customized beverages, enhanced user maintenance experience, and greater overall machine versatility. The adaptive housing 2502 features a unique shape that combines aspects of the standard brew basket with modifications to allow for the accommodation of larger beverage pods. At the points of contact with the brewing machine, adaptive housing 2502 may be designed to match the contours and dimensions of the original brew basket. This design detail ensures the adaptive housing 2502 can be installed in the same position and manner as the standard brew basket, allowing for seamless integration into the brewing machine without the need for machine modifications or special tools.

The adaptive housing 2502 may include two sections, for example, an upper portion and a lower portion. The upper portion of the adaptive housing 2502 may have a first draft angle, for instance, approximately 4 degrees 5 degrees, 6 degrees, or 7 degrees. In some aspects, the upper section may be dimensioned and contoured to accept a standard-sized beverage pod, such as a Keurig KCUP. The lower portion of the adaptive housing 2502 may feature a second draft angle, for instance, approximately 2 degrees, 3 degrees, 4 degrees, or 5 degrees. The draft angle of a beverage pod is an angular dimension describing the relative angle of the sidewall of the beverage pod compared to a perpendicular angle to the bottom or top side of the beverage pod, e.g., a smaller draft angle may be closer to perpendicular than a larger draft angle.

The lower portion of the adaptive housing 2502 may be elongated, such that the pod receptacle 2504 may extend downward further than the standard brew basket to accommodate a beverage pod of extended height. For example, the lower portion may accept a beverage pod that is twice or greater than the height of a typical beverage pod, such as a Keurig KCUP. The combination of these two portions in adaptive housing 2502, with their respective draft angles and dimensions, may allow the housing to cater to a wide range of beverage pod sizes, including those substantially larger than what the standard brew basket can accept. In some aspects, the upper and lower portion may have the same draft angle, in such embodiments, there may be no meaningful distinction between the upper and lower portion, with the exception of the elongated interior space relative to the standard or original brew basket 2514. For example, the exterior surfaces of the adaptive housing 2502 and brew basket 2514 can be generally similar (e.g., substantially geometrically congruent).

The pod receptacle 2504, residing within the internal cavity of the adaptive housing 2502, can be designed specifically to securely hold beverage pods that are larger than the standard size typically accommodated by conventional single-serve beverage brewing machines. The configuration of the pod receptacle 2504 increases the interior volume of the adaptive housing 2502, enabling it to accept a beverage pod that is larger than a standard-sized pod. Contrasting the pod receptacle 2504 against the original brew basket 2514, the pod receptacle 2504 extends farther into the brewing machine, thereby allowing it to accept beverage pods of extended height, potentially those that are twice or greater the height of typical beverage pods, such as a Keurig KCUP. This extended reach is intended to facilitate the secure housing of the larger beverage pod during the brewing process, ensuring optimal interaction between the brewing material and the hot water supplied by the brewing machine for efficient extraction of the beverage. Thus, the pod receptacle 2504 enhances the utility and versatility of the adaptive housing 2502, allowing it to accommodate a broader range of beverage pod sizes and contribute to a wider array of beverage options for users.

The extraction facilitator 2506 can be a component of the adaptive housing 2502, configured to enable the effective extraction of the beverage from a larger-sized beverage pod. The extraction facilitator 2506 may include, for example, one or more piercing elements (e.g., needles) capable of puncturing one or more films of a larger beverage pod 2510. The extraction facilitator 2506 may be located at the bottom, or some other interior location, of the adaptive housing 2502. The extraction facilitator 2506 may create an opening in the larger beverage pod 2510, thereby facilitating the extraction of a brewed beverage out of a beverage pod. The piercing elements of extraction facilitator 2506 may be specially designed to handle the increased volume and potential complexities of larger beverage pods, ensuring a robust and efficient extraction process for a richer and more flavorful beverage output. For example, in aspects of the extraction facilitator 2506, at least two piercing elements may be located inside the adaptive housing 2502, wherein a first piercing element enables the extraction of a brewed beverage, and the at least a second piercing element provides an opening to allow air to flow into the beverage pod during a brewing operation, thereby preventing vacuum pressure from interfering with the extraction of a brewed beverage from a beverage pod.

A beverage transfer mechanism 2508 is a feature of the adaptive housing 2502 that may route the extracted beverage from the pod to the output orifice of the single-serve beverage brewing machine. It can manifest in numerous embodiments, including but not limited to an enlarged exit channel, a nozzle, or a valve that ensures the orderly transfer of the beverage. The beverage transfer mechanism 2508 may be situated at the bottom of the adaptive housing 2502 or at an alternate strategic location within the adaptive housing 2502 to facilitate optimal beverage flow. When the adaptive housing 2502 is correctly positioned within the brewing machine, the beverage transfer mechanism 2508 aligns with the machine's output spout, enabling the seamless transfer of the brewed beverage into the receiving container. The beverage transfer mechanism 2508 may be calibrated to account for the increased volume of the beverage resulting from the use of larger beverage pods, ensuring a consistent and efficient flow of the beverage to the output.

The larger beverage pod 2510 represents the expanded form of a standard beverage pod that is designed to be used in conjunction with the adaptive housing 2502 of the present invention. The primary distinguishing feature of the larger beverage pod 2510 is its increased volume compared to a standard-sized beverage pod, such as a Keurig KCUP. This increased volume facilitates the inclusion of a larger quantity of beverage materials or the addition of supplementary ingredients, resulting in a wider array of beverage possibilities, including stronger or more complex beverage profiles. The larger beverage pod 2510 is designed to be received and held securely by the pod receptacle 2504 during the brewing process. The physical dimensions of the larger beverage pod 2510 may be such that it extends deeper into the brewing machine than a standard-sized pod, made possible by the extended pod receptacle 2504. Furthermore, the larger beverage pod 2510 is designed to interact effectively with the extraction facilitator 2506 for the extraction of the beverage, and the beverage transfer mechanism 2508 for the delivery of the beverage to the output of the machine. The design and use of larger beverage pod 2510, in concert with the adaptive housing 2502, can provide for richer, bolder, and more customizable beverages from single-serve beverage brewing machines.

A standard beverage pod 2512 is shown to demonstrate the typical size of beverage pods currently widely utilized in single-serve beverage brewing machines, such as the Keurig K-CUP. These standard pods are designed to fit within the conventional brew baskets of single-serve machines and contain a predetermined amount of beverage material, such as coffee grounds, tea leaves, or other soluble beverage materials. The standard beverage pod 2512 is punctured or opened by elements of the brewing machine, allowing hot water to pass through the pod and extract the beverage, which is then directed into a cup or other receptacle. The physical dimensions and volume of the standard beverage pod 2512 are restricted by the size of the original brew basket, limiting the amount of beverage material that can be included and, consequently, the boldness and variety of beverages that can be produced. The standard beverage pod 2512, while compatible with, for example, a majority of existing single-serve machines, may present limitations in terms of beverage strength, variety, and potential for additive inclusion.

In one embodiment, including the adaptive housing 2502 and larger beverage pod 2510, offers a solution to these limitations, enhancing the versatility and performance of single-serve beverage brewing machines.

The original Brew Basket 2514 can be a component of a standard single-serve beverage brewing machine, specifically designed to accept and facilitate brewing with a standard beverage pod 2512. The original brew basket 2514 houses the standard beverage pod 2512 during the brewing operation, allowing hot water from the brewing machine to pass through the beverage pod and extract the beverage. The basket includes features for puncturing or opening the beverage pod and guiding the flow of the brewed beverage from the beverage pod to the machine's output. However, the design of the original brew basket 2514 includes a constriction 2516, a design feature that inherently limits the accessible volume of the original brew basket 2514 to the dimensions of the standard beverage pod 2512. The constriction 2516 restricts the size of the beverage pod that can be accommodated in the original brew basket 2514, limiting the amount of beverage material that can be included in the beverage pod and, by extension, the boldness and variety of beverages that can be produced. This limitation imposed by the constriction 2516 presents challenges for users seeking a bolder beverage or wishing to use beverage pods containing additional ingredients. The adaptive housing 2502 of the present invention overcomes this limitation by providing an enhanced brew basket alternative with a larger internal cavity and improved beverage extraction features, designed to accommodate the larger beverage pod 2510 and offer an expanded range of brewing possibilities. The constriction 2516 is a limiting design feature inherent to the original brew basket 2514 in a standard single-serve beverage brewing machine. It represents a dimensional restriction within the original brew basket 2514 that defines the maximum size of the standard beverage pod 2512 that can be accommodated for brewing. This is typically shaped and sized to closely match the dimensions of a standard beverage pod 2512, serving to position and secure the pod during the brewing operation. Constriction 2516, while functional for its intended use, poses a limitation in terms of the variety and boldness of beverages that can be produced by the brewing machine. It restricts the internal volume available for a beverage pod within the original brew basket 2514, which in turn limits the amount of beverage material, and any potential additional ingredients, that can be housed in the pod. This design feature is a key factor contributing to the restrictions on beverage strength and variety encountered with standard single-serve brewing machines. By contrast, the adaptive housing 2502 of the present invention overcomes the limitations imposed by the constriction 2516. It provides an internal cavity of increased size, capable of accommodating the larger beverage pod 2510, thereby expanding the brewing capabilities of the machine, allowing for bolder beverages, and providing the potential for the inclusion of a wider range of additional ingredients.

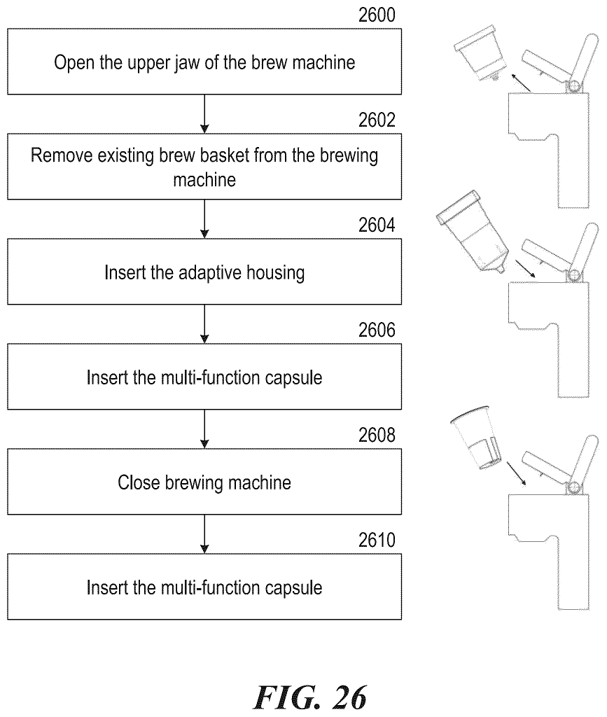

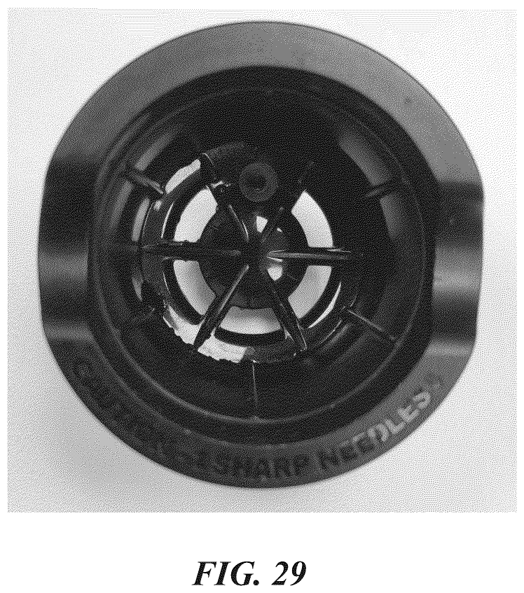

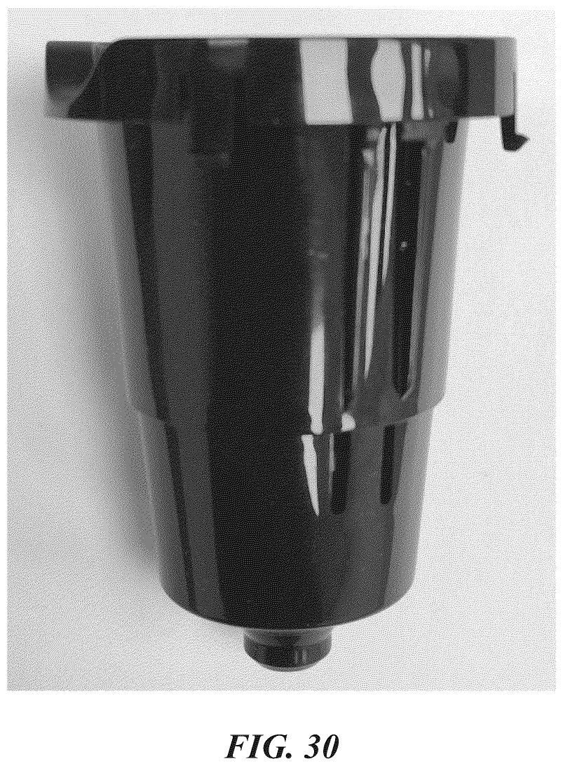

Example installation procedures will now be explained with reference to FIG. 26. The installation procedure applies equally to the beverage brewing system 100 of FIGS. 1 and 20-23 unless indicated otherwise, and the example procedures can be used or modified to install the beverage pods, adaptive housing, and beverage pods discussed in connection with, for example, FIGS. 2A-11, 18A-18C, 24A-25B, and 27A-33G. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The installation procedure can be used to replace standard K-Cup style pods. Given their small capacity, only a limited amount of beverage material, such as coffee grounds, can be accommodated in each pod. This capacity restriction curtails the strength or boldness of the beverage, particularly in larger volume servings, leading to a comparatively weak flavor profile. This poses a significant problem as consumers are increasingly desiring robust, specialty roasts and unique beverages that demand a larger quantity of brewing material.

The capacity constraint of the standard K-Cup style pods also impedes innovations within the single-serve beverage pod market. In recent years, there has been growing interest in incorporating various additives into beverage pods, such as dry creamers, Medium Chain Triglyceride (MCT) oil, grass-fed butter, Cannabidiol (CBD) or Tetrahydrocannabinol (THC) oil, alcohol, and liquid or dry flavored materials. However, the inclusion of such additives further reduces the available space for the core beverage material, thereby exacerbating the issue of weak beverages. Additionally, the limited volume severely restricts the quantity of additive that can be incorporated into a beverage pod. For instance, a traditional Irish coffee recipe may require at least two fluid ounces of alcohol, such as whisky or Kahlua, in addition to strong coffee. Unfortunately, the entire interior volume of a standard K-Cup style pod is less than two fluid ounces, making such a beverage impossible to produce with a single pod.

The restrictions related to pod size are primarily due to the design of the brewing basket, a removable component of the single-serve beverage brewing machine. The primary functions of this basket are to receive the beverage pod, pierce the bottom of the pod, and direct the flow of the liquid to the center of a cup placed beneath to receive the beverage. The design of the current basket in Keurig style brewing machines, however, incorporates significant wasted space. This superfluous space results in additional surfaces and components that require regular cleaning. Due to the neglect of many users to clean these components consistently, contaminants can accumulate over time. This buildup may not only impair the quality of the beverages produced but could also pose serious health and safety concerns.

Moreover, the introduction of additives to beverage pods poses unique challenges due to the design of the standard brewing basket. As many of these additives have a greater viscosity than water or coffee, they are prone to stick to the brew basket, potentially clogging the outlet and creating additional safety issues.

The installation procedure of FIG. 26 can be used to enable use of a replacement brewing basket that can accommodate larger beverage pods. Such a design would enable the use of larger pods in standard, ubiquitous brewing machines, thereby allowing for the production of bolder beverages with a broader range of ingredients. Additionally, the improved basket design enhances the health and safety standards of current brewing machines and reduce the need for regular cleaning and maintenance of the brewing basket for subsequent brewing.

Referring now to FIG. 26, the process can begin with at step 2600 in which the user initiates the process by opening the single-serve beverage brewing machine. This involves lifting or otherwise moving the component of the machine that houses the original brew basket 2514, to expose the brew basket for removal. The specific method of opening the machine will vary depending on the particular model of the machine. For example, in the case of a typical Keurig machine, this involves lifting the handle located at the top of the machine, which opens the brewing compartment.

At step 2602, the original brew basket 2514 is removed from the brewing machine. This typically involves grasping the brew basket and pulling it free from its seated position within the machine. Depending on the design of the machine, there may be a catch or latch mechanism that needs to be disengaged to free the brew basket. For example, some machines may require a slight twist or tilt of the brew basket to disengage it from its seated position.

At step 2604, the adaptive housing 2502 is installed into the single-serve beverage brewing machine. This involves positioning the adaptive housing 2502 in the location formerly occupied by the original brew basket 2514 and pushing or otherwise engaging it into place. The adaptive housing 2502 is designed to match the contours and dimensions of the original brew basket 2514 at the points of contact with the brewing machine, ensuring a secure and seamless fit. For instance, a user may align the adaptive housing 2502 with the brew machine slot or groove, and push it into position until it clicks into place.

At step 2606, the larger beverage pod 2510 is optionally inserted into the pod receptacle 2504 of the adaptive housing 2502. This step is similar to the process of loading a standard beverage pod into the original brew basket, but accommodates a larger pod. In a practical setting, the user might select a larger beverage pod 2510 filled with their preferred coffee blend and additional ingredients, and place it into the adaptive housing 2502. The all or some of the chambers of the larger beverage pod 2510 can be sealed (e.g., hermetically sealed, air-tight sealed, fluidically sealed, etc.) prior to being accessed via brewing pins. For example, each chamber can be hermetically sealed to preserve freshness of beverage ingredients.

At step 2608, the brewing machine is closed, ready for the brewing operation. This involves reversing the action taken in step 2600 to open the machine, thus securing the adaptive housing 2502 and the inserted larger beverage pod 2510, if present, within the machine. In the context of a Keurig machine, this would involve pushing the handle back down to close the brewing compartment.

Finally, at step 2610, the user activates the machine to brew the beverage. This is typically done by pressing a button or turning a dial on the machine to initiate the brewing process. As an example, in a real-world scenario, a user might press the “Brew” button on their machine to initiate the brewing process, and then enjoy a bolder and richer cup of coffee than would have been possible with the original brew basket 2514.

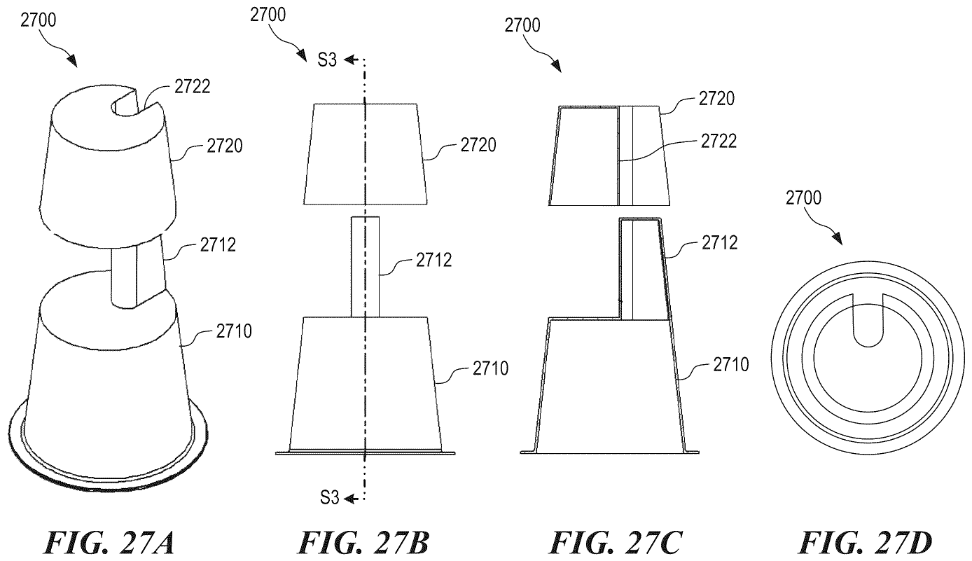

FIG. 27A is an exploded isometric view of a beverage pod 2700. FIG. 27B is a side view of the beverage pod 2700. FIG. 27C is a cross-sectional view taken along plane S3-S3 of FIG. 27B. FIG. 27D is a top view the beverage pod 2700. The beverage pod 2700 includes a first chamber 2710, a second chamber 2720, and an elongate spigot 2712 receivable in a keying feature 2722. The second chamber 2720 can be filled by a user prior to assembling the beverage pod 2700. In some embodiments, the first and second chambers 2710, 2720 can be pre-filled and sealed. A user can select a combination of the chambers to make a desired beverage.

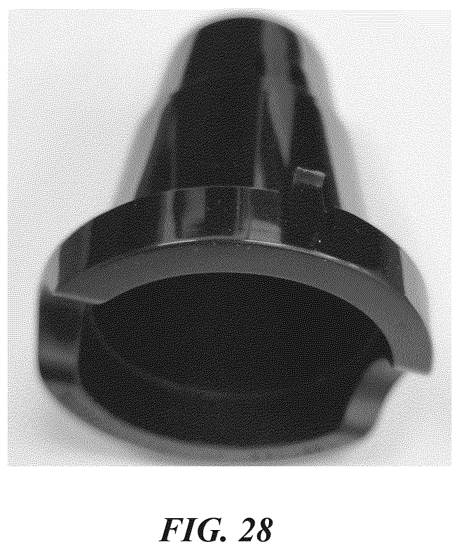

FIGS. 28-31 show various views of a device for adapting a single-serve beverage brewing machine configured to accept a standard size beverage pod in a brew basket, according to at least some embodiments of the present disclosure. The flow-through openings in the device can be selected to achieve desired flow rates. FIG. 31 shows the device disassembled for cleaning.

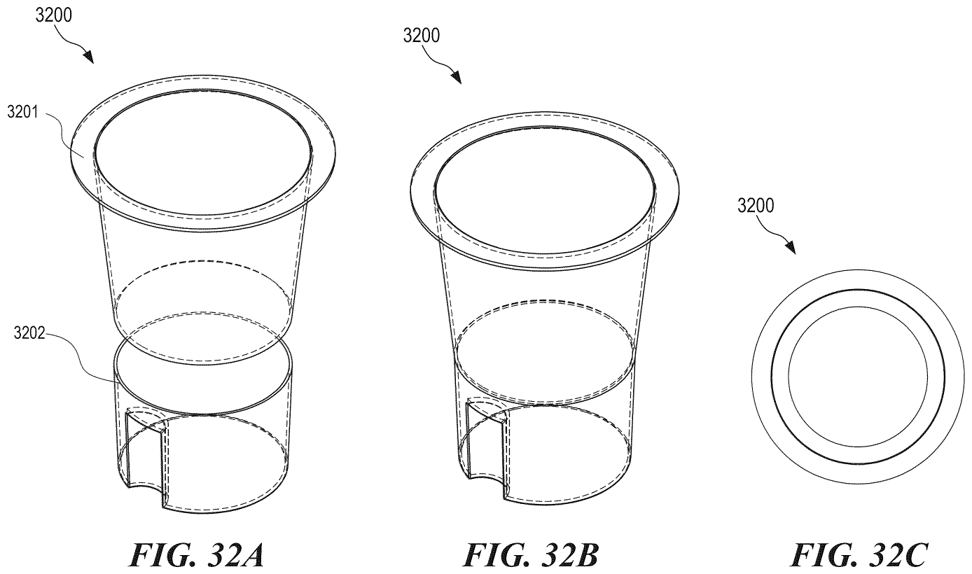

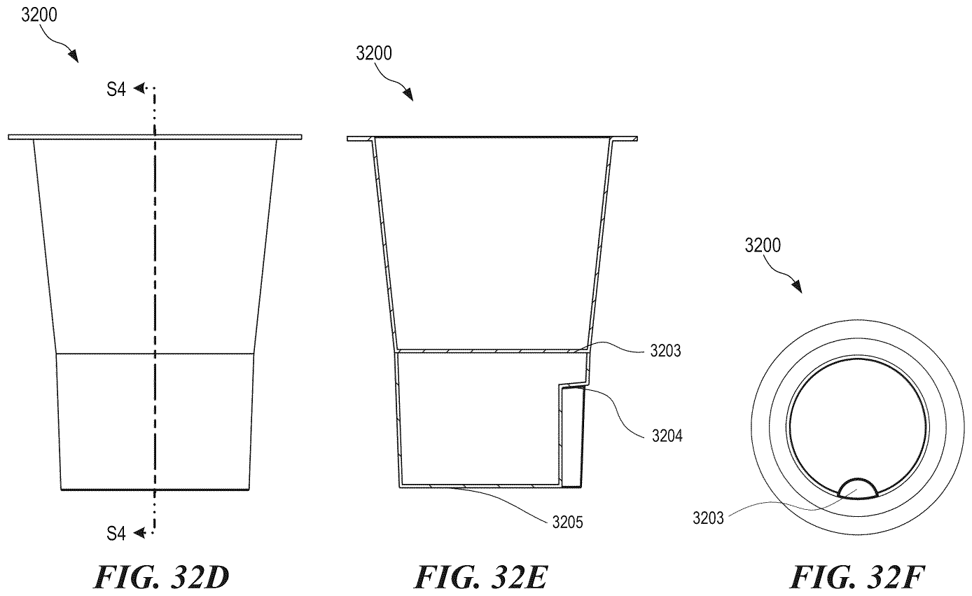

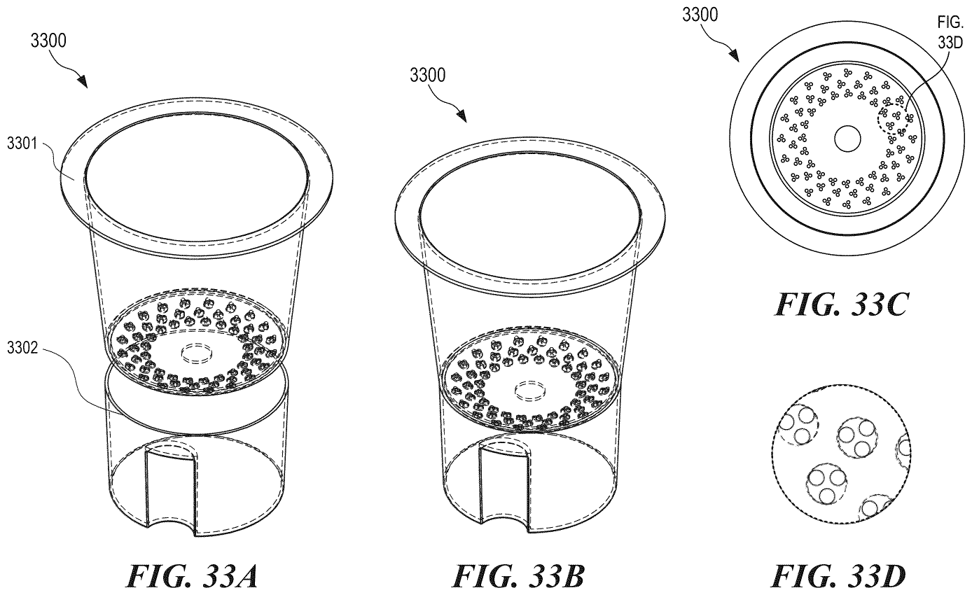

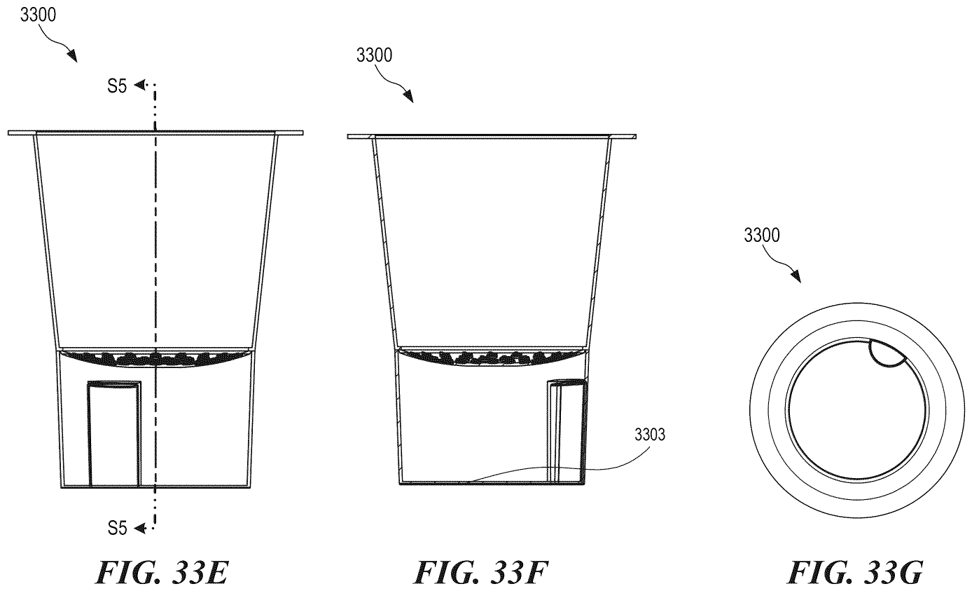

FIGS. 32A-32F show an example multiple compartment beverage pod 3200, and FIGS. 33A-33G show another example multiple compartment beverage pod 3300. The description of one beverage pod applies to the other unless indicated otherwise. Referring now to FIGS. 32A-32F, these figures show the multiple compartment beverage pod 3200 configured to fit inside the adaptive housing. FIG. 32A is an exploded view of the compartment beverage pod 3200. FIG. 32B is an isometric view showing the assembled compartment beverage pod 3200 ready for insertion into a basket or adaptive housing. FIG. 32C is a top view of the compartment beverage pod 3200. FIG. 32D is a side view of the compartment beverage pod, and FIG. 32E is a cross-sectional view taken along plane S4-S4 of FIG. 32D. FIG. 32E is a bottom view of the compartment beverage pod 3200. One or more filters, faceplates, and/or sealing members can be positioned between the compartments.

FIGS. 33A-33G show the multiple compartment pod 3300 configured to fit inside the adaptive housing according to yet another embodiment. FIG. 33A is an exploded view of the compartment beverage pod 3300. FIG. 33B is an isometric view showing the assembled compartment beverage pod 3300 ready for insertion into a beverage basket or adaptive housing. FIG. 33C is a top view showing the assembled compartment beverage pod. FIG. 33D shows tea-brewing group openings to allow brewed tea flow through. The tea leaves remain captured in the first chamber. FIG. 33E is a side view of the compartment beverage pod, and FIG. 32F is a cross-sectional view taken along plane S5-S5 of FIG. 32E. FIG. 33G is a bottom view showing the lower chamber.

The embodiments, features, systems, devices, materials, methods and techniques described herein may, in some embodiments, be similar to any one or more of the embodiments, features, systems, devices, materials, methods and techniques described in the following: U.S. application Ser. No. 15/135,808 (US Pub. No. 20160325898); U.S. application Ser. No. 1515/414,587 (US Pub. No. 20180206667); U.S. application Ser. No. 15/589,743; U.S. application Ser. No. 17/369,641 (US Pub. No. 20210401219); U.S. application Ser. No. 17/375,884 (US Pub. No. 20220017294); PCT Pub. No. WO2021226582; PCT Pub. No. WO2022013792; U.S. application Ser. No. 17/316,135 (US Pub. No. 20210347558); U.S. application Ser. No. 17/323,431 (US Pub. No. 20210354405); U.S. application Ser. No. 17/327,330 (US Pub. No. 20210362941); U.S. application Ser. U.S. application Ser. No. 17/344,541 (US Pub. No. 20210386237); U.S. application Ser. No. 17/346,934 (US Pub. No. 20210386236); U.S. application Ser. No. 17/570,189 (US Pub. No. 20220234774); US App. No. Ser. No. 17/570,188 (US Pub. No. 20220234773); U.S. application Ser. No. 17/570,182 (US Pub. No. 20220234772); U.S. application Ser. No. 17/694,285 (US Pub. No. 20220287494); and U.S. application Ser. No. 17/694,342 (US Pub. No. 20220288828); U.S. application Ser. No. 17/748,993 (US Pub. No. 20230111111); and U.S. application Ser. No. 17/748,995 (US Pub. No. 20230110106).

All of the above-identified patents and applications are incorporated by reference in their entireties. In addition, the embodiments, features, systems, devices, materials, methods and techniques described herein may, in certain embodiments, be applied to or used in connection with any one or more of the embodiments, features, systems, devices, or other matter.

### V. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. A multi-chamber beverage pod for use in a single-serve beverage machine, the multi-chamber pod comprising:
an upper portion defining an upper opening and an upper chamber containing a first beverage material;
a lid covering the upper opening of the upper portion;
a lower portion defining a lower chamber containing a second beverage material, wherein the lower portion includes a brewing pin-receiving shoulder extending inwardly from a sidewall of the lower portion;
a pierceable separator between the upper chamber and the lower chamber; and
a gap between the brewing pin-receiving shoulder and the separator such that when a brewing pin passes upwardly through the pin-receiving shoulder and the separator and a liquid mixes with the first beverage material, a first beverage flows downwardly from the upper chamber, along the gap, and into the lower chamber to mix with the second beverage material to form a second beverage.

2. The multi-chamber beverage pod of example 1, wherein the lower portion is configured to contain a sufficient amount of the first beverage material at a temperature equal to or higher than 90 degrees Celsius for brewing pin sanitization.

3. The multi-chamber beverage pod of example 1 or example 2, wherein the multi-chamber beverage pod is configured keep the brewing pin and a bottom brewing pin that accesses that lower chamber submerged in the first beverage and the second beverage, respectively, for a sanitization period.

4. The multi-chamber beverage pod of example 3, wherein the sanitization period is at least 30 seconds.

5. The multi-chamber beverage pod of any one of examples 1-4, wherein the lower portion is configured to release substantially all of the second beverage material prior to completed delivery of the liquid into the upper portion.

6. The multi-chamber beverage pod of any one of examples 1-5, wherein the first beverage material includes coffee grounds, and wherein the second beverage material includes at least one fluid ounce of a beverage liquid.

7. The multi-chamber beverage pod of any one of examples 1-6, wherein the lower portion has a sidewall and a bottom, wherein the sidewall includes a brewing pin-receiving channel extending from the shoulder to the bottom.

8. The multi-chamber beverage pod of any one of examples 1-7, wherein the shoulder has an upper surface facing the separator and a lower surface configured to be pierced by the brewing pin while the upper surface remains spaced apart from the separator and the brewing pin pierces the separator.

9. The multi-chamber beverage pod of any one of examples 1-8, wherein the lower portion is configured to maintain the gap while the brewing pin accesses both the lower and upper chambers.

10. The multi-chamber beverage pod of any one of examples 1-9, wherein a distance between the shoulder and the separator is at least 2 mm.

11. The multi-chamber beverage pod of any one of examples 1-10, wherein one or both of the upper chamber and the lower chamber are hermetically sealed prior to being accessed via one or more brewing pins.

12. The multi-chamber beverage pod of any one of examples 1-11, wherein a ratio of a first volume of the upper chamber to a second volume of the lower chamber is equal to or greater than 1.

13. The multi-chamber beverage pod of any one of examples 1-12, wherein the pierceable separator is a film welded to at least one of the upper portion or lower portion.

14. The multi-chamber beverage pod of any one of examples 1-12, wherein the pierceable separator is integrally formed with an upper sidewall of the upper portion.

15. The multi-chamber beverage pod of any one of examples 1-14, wherein an outer diameter of the lower portion is smaller than an outer diameter of the upper portion.

16. The multi-chamber beverage pod of any one of examples 1-15, wherein the shoulder is configured to rest upon an internal ledge of the single-serve beverage machine to position the upper portion at a standard beverage pod position of the single-serve beverage machine.

17. A pod holder for use in a single-serve beverage machine, the pod holder comprising:
a lower portion having (i) a groove extending from a bottom of the lower portion towards a top of the lower portion and (ii) a central opening at the bottom;
an upper portion coupled to the top of the lower portion, wherein the lower portion and the upper portion define a lip therebetween, wherein the lip extends radially outward from the lower portion to the upper portion;
a first needle coupled to the bottom of the lower portion, wherein the first needle is configured to pierce a bottom of a beverage pod; and
a second needle coupled to a terminal end of the groove adjacent the top of the lower portion, wherein the second needle is configured to pierce a separator of the beverage pod.

18. The pod holder of example 17, wherein the first needle includes:
a first aperture positioned on a first end of the first needle to receive fluid from the beverage pod upon the first needle piercing the bottom;
a second aperture positioned on a side of the first needle to direct a first portion of the fluid
towards the central opening of the lower portion; and a third aperture positioned on a second end of the first needle to direct a second portion of the fluid out of the pod holder.

19. The pod holder of example 17 or example 18, wherein the second needle includes:
a first aperture positioned on an end of the second needle to receive fluid from the beverage pod upon the second needle piercing the separator; and
a second aperture positioned on a side of the second needle to direct the fluid towards the lower portion.

20. The pod holder of any one of examples 17-19, wherein each of the lower portion and the upper portion comprises a tapered cylinder.

21. The pod holder of any one of examples 17-20, wherein the lower portion has a first length between 2-2.5 inches, and wherein the upper portion has a second length between 1.5-2 inches.

22. A system for adapting a single-serve beverage brewing machine configured to accept a standard size beverage pod, the system comprising:
an adaptive housing configured to be placed within the single-serve beverage brewing
machine in a location configured to be occupied by a brew basket configured to hold the standard size beverage pod, the adaptive housing having an internal cavity larger than the standard size beverage pod accepted by the brew basket;
a pod receptacle located within the internal cavity of said the adaptive housing, wherein the pod receptacle is configured to accept an enlarged beverage pod larger than the standard size beverage pod; and
one or more puncture elements configured to facilitate extraction of the beverage from the enlarged beverage pod when the enlarged beverage pod is placed within the pod receptacle and the adaptive housing is located within the single-serve beverage brewing machine such that the single-serve beverage brewing machine is capable of brewing a beverage from the enlarged beverage pod.

23. The system of example 22, wherein the adaptive housing is a pod holder with a plurality of tapered sections each configured to hold a respective sealed portion of the enlarged beverage pod.

24. The system of example 22 or example 23, wherein the one or more puncture elements each are brew pins.

25. The system of any one of examples 22-24, wherein the pod receptacle includes a stepped internal cavity configured to receive an enlarged beverage pod with a lip configured to rest upon a step of the pod receptacle.

26. The system of any one of examples 22-25, wherein the one or more puncture elements are configured to contact beverage inside the enlarged beverage pod to sanitize beverage-contacting surfaces of the one or more puncture elements.

27. The system of any one of examples 22-26, wherein the adaptive housing includes:
a lower portion having (i) a keying feature extending from a bottom of the lower portion towards a top of the lower portion and (ii) a central opening at the bottom; and
an upper portion coupled to the top of the lower portion, wherein the lower portion and the upper portion define a shoulder therebetween, wherein the shoulder extends radially outward from the lower portion to the upper portion, and at least one of the puncture elements extends upwardly from the shoulder toward a pod-receiving opening of the adaptive housing.

28. A dual-chamber beverage pod for use in a single-serve beverage machine, the dual-chamber pod comprising:
a lower portion having a groove extending along a sidewall of the lower portion towards a top of the lower portion and containing a first beverage material;
a bottom connected to the lower portion;
an upper portion coupled to the top of the lower portion;
a lip that extends radially outward from the lower portion;
a separator between a lower chamber of the lower portion and an upper chamber of upper portion; and
a lidding attached to a top of the upper portion to seal a second beverage material in the upper chamber of the upper portion.

29. The dual-chamber pod of example 28, wherein a terminal end of the groove extends parallel to the separator, and wherein, when the dual-chamber pod is in use, the terminal end of the groove and the separator are configured to be pierced by a same needle.

30. The dual-chamber pod of example 28 or example 29, wherein the upper portion is coupled to the top of the lower portion via thermal welding or ultrasonic welding.

31. The dual-chamber pod of any one of examples 28-30, wherein the first chamber is configured to store at least one of sugar, dairy products, or non-diary alternative products, and wherein the second chamber is configured to store coffee blend.

32. The dual-chamber pod of any one of examples 28-31, wherein the separator comprises a mesh configured to hold tea leaves.

33. An injection molding system, comprising:
an injection molding apparatus including:
   a positive molding part, wherein the positive molding part comprises a tapered component; and
   a negative molding part, wherein the negative molding part defines a tapered cavity and a gate in fluid communication with the tapered cavity, wherein the gate is coupled to receive a melted polymer;
a feeder configured to inject the melted polymer from a source to the gate of the negative molding part;
a driver configured to move the positive molding part toward or away from the negative molding part; and
a controller operably coupled to the feeder and the driver, wherein the controller is configured to cause the injection molding system to perform a process including:
   positioning, using the driver, the positive molding part spaced apart from the negative molding part such that the injection molding apparatus is in an open state;
   injecting, using the feeder, a predetermined volume of the melted polymer into the tapered cavity via the gate;
   moving, using the driver, the positive molding part toward the negative molding part such that the tapered component spreads the predetermined volume of the melted polymer in the tapered cavity into at least a portion of a container having a groove extending along a side of the container, and such that the injection molding apparatus in a closed state;
   cooling the melted polymer such that the polymer solidifies and retains a shape of the at least the portion of the container; and
   moving, using the driver, the positive molding part away from the negative molding part such that the injection molding apparatus returns to the open state.

34. The injection molding system of example 33, wherein the container comprises a pod holder having a lower portion and an upper portion attached to the lower portion, wherein the lower portion and the upper portion define a lip therebetween, wherein the lip extends radially outward from the lower portion to the upper portion.

35. The injection molding system of example 34, wherein the groove extends along the lower portion of the pod holder, and wherein the lip is positioned between the groove and the upper portion of the pod holder.

36. The injection molding system of example 34 or example 35, wherein the pod holder is shaped to secure a first needle at a bottom portion of the pod holder and a second needle above the groove.

37. The injection molding system of example 33, further comprising:
a second injection molding apparatus including:
   a second positive molding part, wherein the positive molding part comprises a second tapered component; and
   a second negative molding part, wherein the negative molding part defines a second tapered cavity and a second gate in fluid communication with the second tapered cavity, wherein the second gate is coupled to receive the melted polymer,
wherein the second injection molding apparatus is configurable between (i) an open state in which the second positive and second negative molding parts are separated and (ii) a closed state in which the second positive and second negative molding parts are in contact, and
wherein, when the second injection molding apparatus is in the closed state, the second tapered component and the second tapered cavity are configured to shape the melted polymer into a cylindrical shell.

38. The injection molding system of example 37, wherein the at least a portion of the container formed by the injection molding apparatus comprises a lower portion, wherein the cylindrical shell formed by the second injection molding apparatus comprises an upper portion, and wherein the lower portion and the upper portion are configured to be attached to form a dual-chamber pod.

39. The injection molding system of example 38, wherein the lower portion and the upper portion, when attached, are configured to define a lip therebetween, wherein the lip extends radially outward from the lower portion to the upper portion.

40. The injection molding system of example 38 or example 39, wherein the cylindrical shell includes a bottom rim surface suitable for attaching a film thereon via thermal welding or ultrasonic welding, wherein the film is positioned to define a first chamber surrounded by the lower portion and a second chamber surrounded by the upper portion.

41. The injection molding system of claim 38, wherein the cylindrical shell includes an upper rim flange extending radially outward.

42. The injection molding system of any one of examples 33-41, wherein the at least the portion of the container includes a bottom rim surface suitable for attaching a film thereon via thermal welding or ultrasonic welding.

43. A method comprising:
piercing a multi-chamber beverage pod using a plurality of brewing pins;
delivering a heated liquid into the multi-chamber beverage pod to submerge portions of the plurality of brewing pins positioned in the multi-chamber beverage pod; and
allowing the heated liquid to flow sequentially through chambers of the multi-chamber beverage pod accessed via the plurality of brewing pins to produce a beverage.

44. The method of example 43, wherein at least one of the heated liquid delivered into the multi-chamber beverage pod or the beverage exiting the multi-chamber beverage pod are at a temperature equal to or higher than 90 degree Celsius.

45. The method of example 43 or example 44, wherein both the heated liquid delivered into the multi-chamber beverage pod and the beverage exiting the multi-chamber beverage pod are at a temperature equal to or higher than 90 degree Celsius.

46. The method of any one of examples 43-45, further comprising:
allowing the heated liquid to flow along each of the plurality of brewing pins to clean the plurality of brewing pins of beverage material.

47. The method of any one of examples 43-46, wherein the chambers each contain a respective beverage material.

48. The method of any one of examples 43-47, wherein the multi-chamber beverage pod is configured to allow fluid flow only in one direction through the chambers.

49. The method of any one of examples 43-48, further comprising concurrently accessing each of the chambers of the multi-chamber beverage pod with a respective one of the brewing pins.

50. The method of any one of examples 43-49, further comprising:
removing a brew basket from a brew basket opening of a brewing machine configured to output the heated liquid; and
installing a beverage pod holder that has an exterior configured to fit the brew basket opening,
wherein the multi-chamber beverage pod extends downwardly past the brew basket opening to position at least one of the brewing pins below the brew basket opening.

51. The method of example 50, wherein the beverage pod holder includes the plurality of brewing pins positioned at opposing sides of a beverage pod-receiving cavity of the beverage pod holder.

52. The method of any one of examples 43-51, wherein the multi-chamber beverage pod releases at least one first beverage material that exits the multi-chamber beverage pod while the multi-chamber beverage pod while contains at least one second beverage material.

53. The method of example 52, wherein the at least one first beverage material includes one or more of alcohol, powder, oil, or syrup.

54. The method of example 52 or example 53, wherein the at least one second beverage material includes one or more of coffee grounds or tea leaves.

55. The method of any one of examples 43-54, wherein the heated liquid flows in downwardly through a series of the chambers in the multi-chamber beverage pod to remove beverage material from the series of the chambers.

### VI. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations, shear strength, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

What is claimed is:

1. A multi-chamber beverage pod for use in a single-serve beverage machine, the multi-chamber pod comprising:
an upper portion defining an upper opening and an upper chamber containing a first beverage material;
a lid covering the upper opening of the upper portion;
a lower portion defining a lower chamber containing a second beverage material, wherein the lower portion includes a brewing pin-receiving shoulder extending inwardly from a sidewall of the lower portion;
a pierceable separator between the upper chamber and the lower chamber; and
a gap between the brewing pin-receiving shoulder and the separator such that when a brewing pin passes upwardly through the pin-receiving shoulder and the separator and a liquid mixes with the first beverage material, a first beverage flows downwardly from the upper chamber, along the gap, and into the lower chamber to mix with the second beverage material to form a second beverage.

2. The multi-chamber beverage pod of claim 1, wherein the lower portion is configured to contain a sufficient amount of the first beverage material at a temperature equal to or higher than 90 degrees Celsius for brewing pin sanitization.

3. The multi-chamber beverage pod of claim 1, wherein the multi-chamber beverage pod is configured keep the brewing pin and a bottom brewing pin that accesses that lower chamber submerged in the first beverage and the second beverage, respectively, for a sanitization period.

4. The multi-chamber beverage pod of claim 3, wherein the sanitization period is at least 30 seconds.

5. The multi-chamber beverage pod of claim 1, wherein the lower portion is configured to release substantially all of the second beverage material prior to completed delivery of the liquid into the upper portion.

6. The multi-chamber beverage pod of claim 1, wherein the first beverage material includes coffee grounds, and wherein the second beverage material includes at least one fluid ounce of a beverage liquid.

7. The multi-chamber beverage pod of claim 1, wherein the lower portion has a sidewall and a bottom, wherein the sidewall includes a brewing pin-receiving channel extending from the shoulder to the bottom.

8. The multi-chamber beverage pod of claim 1, wherein the shoulder has an upper surface facing the separator and a lower surface configured to be pierced by the brewing pin while the upper surface remains spaced apart from the separator and the brewing pin pierces the separator.

9. The multi-chamber beverage pod of claim 1, wherein the lower portion is configured to maintain the gap while the brewing pin accesses both the lower and upper chambers.

10. The multi-chamber beverage pod of claim 1, wherein a distance between the shoulder and the separator is at least 2 mm.

11. The multi-chamber beverage pod of claim 1, wherein one or both of the upper chamber and the lower chamber are hermetically sealed prior to being accessed via one or more brewing pins.

12. The multi-chamber beverage pod of claim 1, wherein a ratio of a first volume of the upper chamber to a second volume of the lower chamber is equal to or greater than 1.

13. The multi-chamber beverage pod of claim 1, wherein the pierceable separator is a film welded to at least one of the upper portion or lower portion.

14. The multi-chamber beverage pod of claim 1, wherein the pierceable separator is integrally formed with an upper sidewall of the upper portion.

15. The multi-chamber beverage pod of claim 1, wherein an outer diameter of the lower portion is smaller than an outer diameter of the upper portion.

16. The multi-chamber beverage pod of claim 1, wherein the shoulder is configured to rest upon an internal ledge of the single-serve beverage machine to position the upper portion at a standard beverage pod position of the single-serve beverage machine.

17. A pod holder for use in a single-serve beverage machine, the pod holder comprising:
a lower portion having (i) a groove extending from a bottom of the lower portion towards a top of the lower portion and (ii) a central opening at the bottom;
an upper portion coupled to the top of the lower portion, wherein the lower portion and the upper portion define a lip therebetween, wherein the lip extends radially outward from the lower portion to the upper portion;
a first needle coupled to the bottom of the lower portion, wherein the first needle is configured to pierce a bottom of a beverage pod; and
a second needle coupled to a terminal end of the groove adjacent the top of the lower portion, wherein the second needle is configured to pierce a separator of the beverage pod.

18. The pod holder of claim 17, wherein the first needle includes:
a first aperture positioned on a first end of the first needle to receive fluid from the beverage pod upon the first needle piercing the bottom;
a second aperture positioned on a side of the first needle to direct a first portion of the fluid towards the central opening of the lower portion; and
a third aperture positioned on a second end of the first needle to direct a second portion of the fluid out of the pod holder.

19. The pod holder of claim 17, wherein the second needle includes:
a first aperture positioned on an end of the second needle to receive fluid from the beverage pod upon the second needle piercing the separator; and
a second aperture positioned on a side of the second needle to direct the fluid towards the lower portion.

20. The pod holder of claim 17, wherein each of the lower portion and the upper portion comprises a tapered cylinder.

21. The pod holder of claim 17, wherein the lower portion has a first length between 2-2.5 inches, and wherein the upper portion has a second length between 1.5-2 inches.

22. An injection molding system, comprising:
an injection molding apparatus including:
a positive molding part, wherein the positive molding part comprises a tapered component; and
a negative molding part, wherein the negative molding part defines a tapered cavity and a gate in fluid communication with the tapered cavity, wherein the gate is coupled to receive a melted polymer;
a feeder configured to inject the melted polymer from a source to the gate of the negative molding part;
a driver configured to move the positive molding part toward or away from the negative molding part; and
a controller operably coupled to the feeder and the driver, wherein the controller is configured to cause the injection molding system to perform a process including:
positioning, using the driver, the positive molding part spaced apart from the negative molding part such that the injection molding apparatus is in an open state;
injecting, using the feeder, a predetermined volume of the melted polymer into the tapered cavity via the gate;
moving, using the driver, the positive molding part toward the negative molding part such that the tapered component spreads the predetermined volume of the melted polymer in the tapered cavity into at least a portion of a container having a groove extending along a side of the container, and such that the injection molding apparatus in a closed state;
cooling the melted polymer such that the polymer solidifies and retains a shape of the at least the portion of the container; and
moving, using the driver, the positive molding part away from the negative molding part such that the injection molding apparatus returns to the open state.

23. The injection molding system of claim 22, wherein the container comprises a pod holder having a lower portion and an upper portion attached to the lower portion, wherein the lower portion and the upper portion define a lip therebetween, wherein the lip extends radially outward from the lower portion to the upper portion.

24. The injection molding system of claim 23, wherein the groove extends along the lower portion of the pod holder, and wherein the lip is positioned between the groove and the upper portion of the pod holder.
